(19) United States
(12) Patent Application Publication
(10) Pub. No.: US 2017/0080991 A1
(43) Pub. Date: Mar. 23, 2017

(54) LASER PROJECTION DEVICE

(71) Applicant: SMIDSY LTD., Clifton (GB)

(72) Inventors: Matthew White, Bexhill-on-Sea (GB); Emily Brooke, Clifton (GB)

(73) Assignee: SMIDSY LTD.

(21) Appl. No.: 15/256,847

(22) Filed: Sep. 6, 2016

(30) Foreign Application Priority Data
Sep. 4, 2015 (GB) 1515731.6

(51) Int. Cl. B62J 6/00; G02B 27/42; G03B 21/20

(52) U.S. Cl. CPC B62J 6/00; B62J 6/001; G03B 21/2066; G03B 21/2093; G02B 27/4205

(57) ABSTRACT

A laser projection device for attachment to a bicycle, the device comprising a laser light source operable to emit a beam of laser light in a first direction, a mirror, a diffractive optical element, the arrangement being such that, in use, a beam of laser light emitted by the laser light source is reflected by the mirror through the diffractive optical element and emitted from the device in a second direction, said second direction being non-parallel to said first direction.

### FIELD OF THE INVENTION

The present invention relates to a laser projection device for attachment to a bicycle, a method of projecting a laser light image on a surface from a bicycle, a method of retrofitting a bicycle with a laser projection device, and a method of charging a cell and a supercapacitor.

### BACKGROUND TO THE INVENTION

Many large cities, such as Paris or London, operate bicycle rental schemes whereby a tourist or commuter can remove a rental bicycle from a stand, operate it for a limited period of time and then return it to the a stand at the same or different location. In London, these bicycles are known as Barclays® Bikes, Santander® Bikes, or, more colloquially, ‘Boris Bikes’.

Such bicycles are commonly equipped with conventional bike lights which are powered by a dynamo attached to a wheel of the bicycle, and which blink continuously while the bicycle is in use. While these lights do provide some visibility of the bicycle to other road users, they have often been found to be inadequate, and many accidents occur between motor vehicles and rented bicycles. Frequent users of these rented bicycles have taken to carrying their own supplementary battery powered bicycle lights for improved illumination, and wearing high-visibility jackets to improve their visibility to other road users.

It is an aim of the present invention to improve the visibility of bicycles, for example rented bicycles, to other road users, without the need for supplementary battery powered lights or high visibility jackets.

As prior art there may be mentioned WO2014080168, which discloses a linear laser light projector for a bicycle. While the laser light projector in WO2014080168 does greatly increase the visibility of a bicycle, there are certain bicycles, such as rented bicycles, where it is inconvenient to attach a linear laser light projector, as a suitable mounting point is not available.

### SUMMARY OF THE INVENTION

In accordance with a first aspect of the invention there is provided a laser projection device for attachment to a bicycle, the device comprising:
a laser light source operable to emit a beam of laser light in a first direction;
a mirror; and
a diffractive optical element,
wherein, in use, a beam of laser light emitted by the laser light source is reflected by the mirror through the diffractive optical element and emitted from the device in a second direction, said second direction being non-parallel to said first direction.

In accordance with a second aspect of the invention there is provided a method of projecting a laser light image onto a surface from a bicycle, the method comprising the steps of:
providing a laser light source, a mirror and a diffractive optical element on the bicycle;
causing the laser light source to emit a beam of laser light in a first direction;
reflecting the beam of laser light by the mirror through the diffractive optical element; and
emitting the reflected beam of laser light from the device in a second direction, said second direction being non-parallel to said first direction, to produce a laser light image on the surface.

The mirror could be held by a mirror holder, the diffractive optical element could be held by a diffractive optical element holder, and, in use, the mirror could be clamped between the mirror holder, an intermediate piece and the diffractive optical element holder. The mirror holder could have an angled seat portion which is angled obliquely to the beam of laser light emitted by the laser light source in use and dimensioned to receive the mirror. The intermediate piece could comprise a pair of projecting arms, said arms each having a respective angled portion whose angle corresponds to the angle of the angled seat portion, and, in use the projecting arms could act to clamp the peripheral portions of the mirror to the mirror holder. The diffractive optical element could be clamped between the diffractive optical element holder and the intermediate piece. The diffractive optical element holder could comprise an aperture dimensioned to receive a portion of the diffractive optical element and prevent rotation thereof.

The laser light source, mirror, mirror holder, intermediate piece, diffractive optical element and diffractive optical element holder could be are contained within a housing. The diffractive optical element holder could comprise at least one projecting arm comprising an internal bore which is hollowed to receive a self-tapping screw. The housing could comprise an aperture, and a screw could be passed through said aperture to secure the diffractive optical element holder to the housing. The diffractive optical element holder, diffractive optical element, intermediate piece, mirror and mirror holder could be arranged in a stack, such that tightening of the screw draws the diffractive optical element holder towards the housing to compress the stack together.

The laser light source could be inserted into a cylindrical cavity within the housing through a cylindrical aperture.

The housing could substantially mimic a standard bicycle reflector. The housing could comprise a curved front surface. A reflective sticker could be applied to the curved front surface.

The diffractive optical element could be configured to produce an image of a bicycle in the beam of laser light.

Said second direction could be substantially perpendicular to said first direction

In accordance with a third aspect of the invention there is provided a method of retrofitting a bicycle with a laser projection device, the bicycle having a dynamo electrically connected to conventional lighting, the method comprising the steps of:
disconnecting the dynamo from the conventional lighting;
electrically connecting the dynamo to a power unit containing a rechargeable cell, said cell being connected to a laser projection device as described above and configured to supply electrical power thereto; and
connecting the conventional lighting to the electrical connection between the dynamo and the power unit.

In accordance with a fourth aspect of the invention there is provided a method of charging a cell and a supercapacitor comprising:
supplying an approximately AC electrical signal comprising a plurality of cycles to an electrical circuit including the cell and the supercapacitor;
charging the supercapacitor on a first subset of the plurality of cycles; and
charging the cell on a second subset of the plurality of cycles,
wherein the second subset does not overlap with the first subset.

Charging the supercapacitor may limit the voltage of the AC electrical signal, and the cell may be configured only to charge at voltages greater than said voltage limit.

### BRIEF DESCRIPTION OF THE DRAWINGS

FIG. 1a is a front perspective view of a laser projection device according to an embodiment of the present invention;

FIG. 1b is a rear perspective view of the laser projection device of FIG. 1a;

FIG. 1c is a front view of the laser projection device of FIG. 1a;

FIG. 1d a side view of the laser projection device of FIG. 1a;

FIG. 1e is a rear view of the laser projection device of FIG. 1a;

FIG. 1f is a cross-sectional view of the laser projection device taken along line A-A in FIG. 1c;

FIG. 2 is an exploded front perspective view of the laser projection device of FIG. 1a;

FIG. 3a is a front perspective view of the DOE holder shown in FIG. 2;

FIG. 3b is a rear perspective view of the DOE holder of FIG. 3a;

FIG. 3c is a side view of the DOE holder of FIG. 3a;

FIG. 3d is a cross-sectional view of the DOE holder taken across the line A-A in FIG. 3c;

FIG. 4a is a front perspective view of the intermediate piece shown in FIG. 2;

FIG. 4b is a rear perspective view of the intermediate piece of FIG. 4a;

FIG. 4c is a rear view of the intermediate piece of FIG. 4a;

FIG. 4d is a cross-sectional view of the intermediate piece taken across the line B-B in FIG. 4c;

FIG. 5a is a front perspective view of the mirror holder shown in FIG. 2;

FIG. 5b is a rear perspective view of the mirror holder of FIG. 5a;

FIG. 5c is a rear view of the mirror holder of FIG. 5a;

FIG. 5d is a cross-sectional view of the mirror holder taken across the line C-C in FIG. 5c;

FIG. 6a is a rear view of a power unit suitable for use with the laser projection device of FIGS. 1-2;

FIG. 6b is a bottom view of the power unit of FIG. 6a;

FIG. 6c is a side view of the power unit of FIG. 6a;

FIG. 6d is a front view of the power unit of FIG. 6a;

FIG. 6e is a cross-sectional view of the power unit taken across line A-A in FIG. 6d;

FIG. 7 is an exploded perspective view of the power unit of FIG. 6a;

FIG. 8 is a more detailed schematic view of the printed circuit board shown in FIG. 7;

FIG. 9 is an exploded perspective view of a bicycle frame to which the laser projection device of FIGS. 1-2 and the power unit of FIGS. 5-6 may be attached;

FIG. 10 shows a completely attached laser projection device and front plate;

FIG. 11 shows a front view of the completely attached laser projection device and front plate of FIG. 10;

FIG. 12 shows the completely attached laser projection device and front plate of FIG. 10 viewed from above in cross-section;

FIG. 13 shows the completely attached laser projection device and front plate of FIG. 10 viewed from the side in cross-section;

FIG. 14 shows the completely attached laser projection device and front plate of FIG. 10 viewed from a front perspective view with a partial cut-away;

FIG. 15 shows circuitry connecting the laser projection device to the power unit;

FIG. 16 shows another view of circuitry connecting the laser projection device to the power unit;

FIG. 17 is an exemplary voltage waveform for a typical bicycle dynamo without load;

FIG. 18 is an exemplary voltage and current waveform for a typical bicycle dynamo while charging a supercapacitor, where the bicycle is travelling at a relatively low speed;

FIG. 19 is an exemplary voltage and current waveform for a typical bicycle dynamo while charging a supercapacitor, where the bicycle is accelerating from a relatively low speed;

FIG. 20 is an exemplary voltage and current waveform for a typical bicycle dynamo while charging a supercapacitor, where the bicycle is travelling at a relatively high speed;

FIG. 21 shows the voltage waveform of FIG. 20, with the dynamo current waveform replaced with a cell current waveform for the same period of time; and

FIG. 22 shows an exemplary voltage waveform for the laser output.

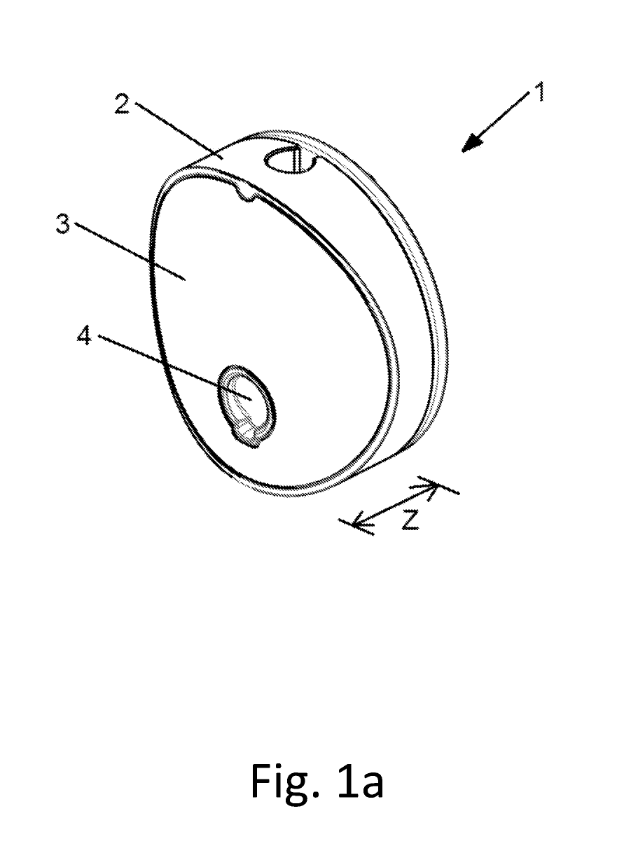

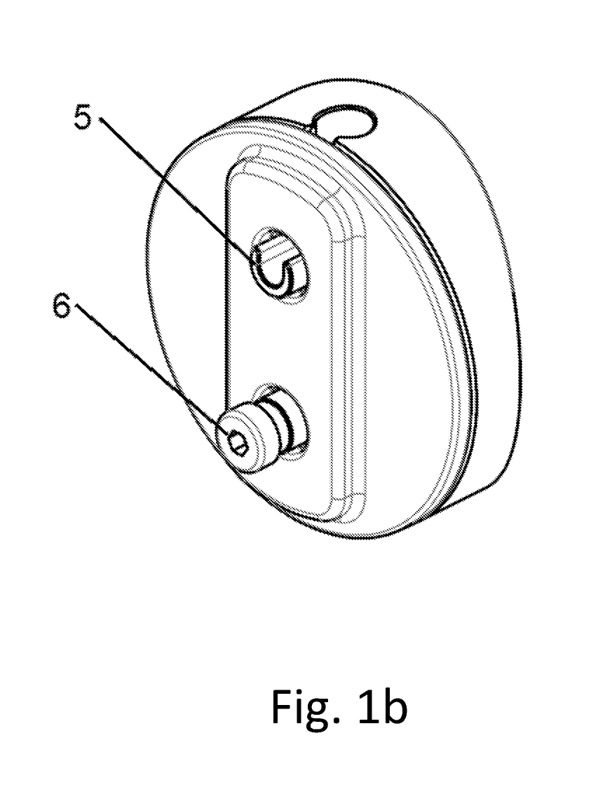

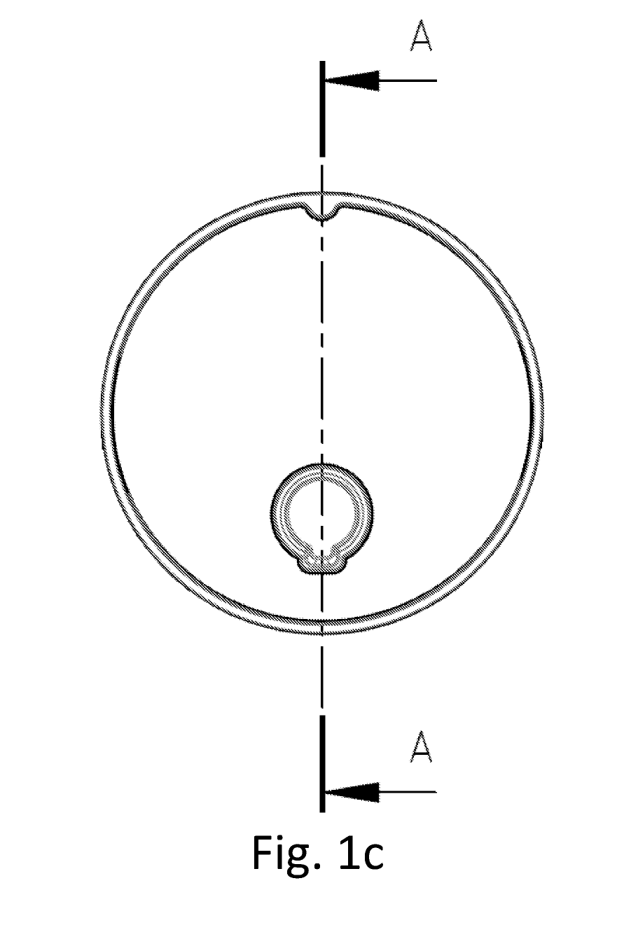

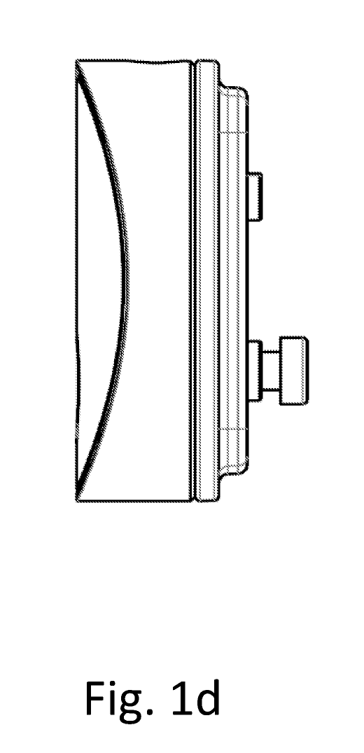

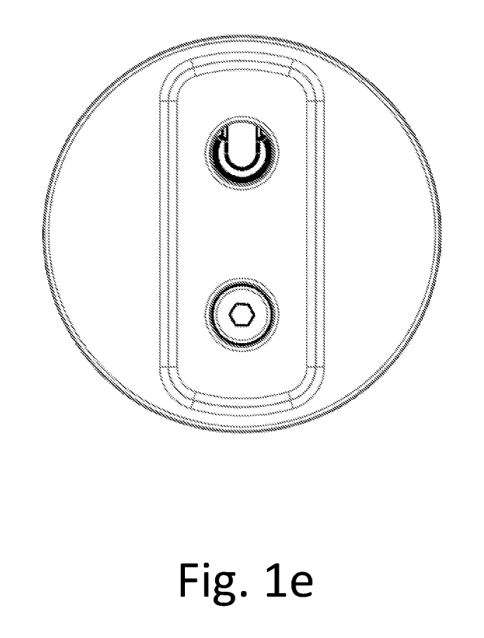

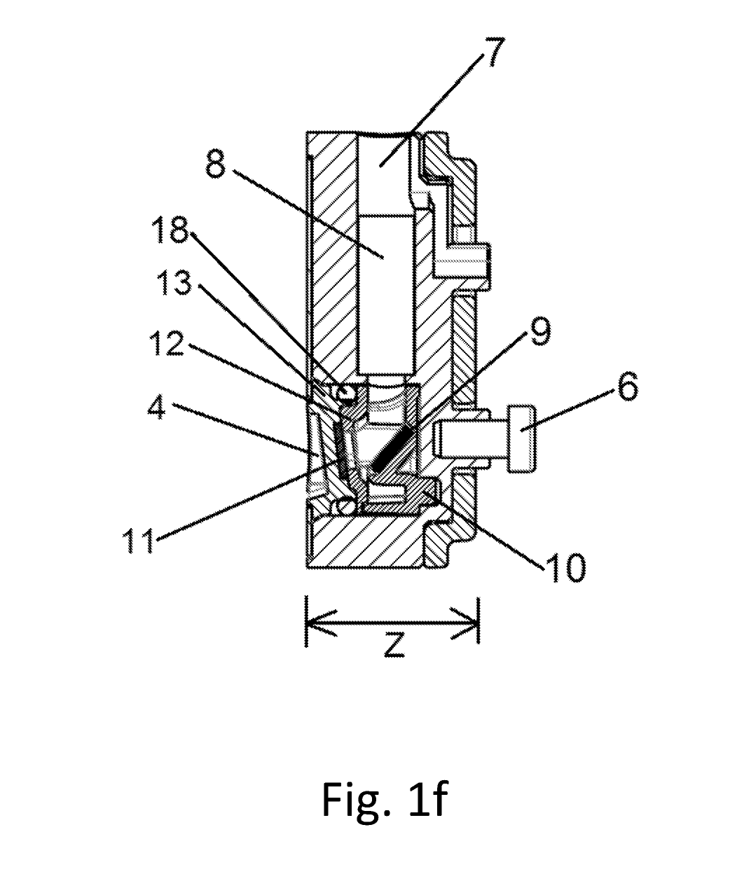

FIG. 1 schematically shows a front perspective view of a laser projection device 1 according to an embodiment of the present invention. The components of the laser projection device 1 have been arranged to fit within a housing 2 that mimics the shape of a standard bike reflector. Although the depth of the housing 2, indicated by Z, is slightly thicker than a standard reflector in practice, this allows the laser projection device 1 to fit onto a standard bike front plate with attachment means for bike reflectors. As these are often already present on rental bicycles, this means that a retrofit operation to attach the laser projection device 1 to a rental bicycle may not require any additional clamps or fittings.

A front surface of the housing 2 is curved and a reflective sticker 3 is applied. The curvature of the front surface of the housing increases the directions in which the reflective sticker 3 reflects light, increasing its visibility. The front surface of the housing 2 also includes an aperture 4, through which laser light is projected in use. The reflective sticker 3 is waterproof, and overlaps the rim of the aperture 4 to create a watertight seal, preventing water ingress from the environment to the interior of the laser projection device 1.

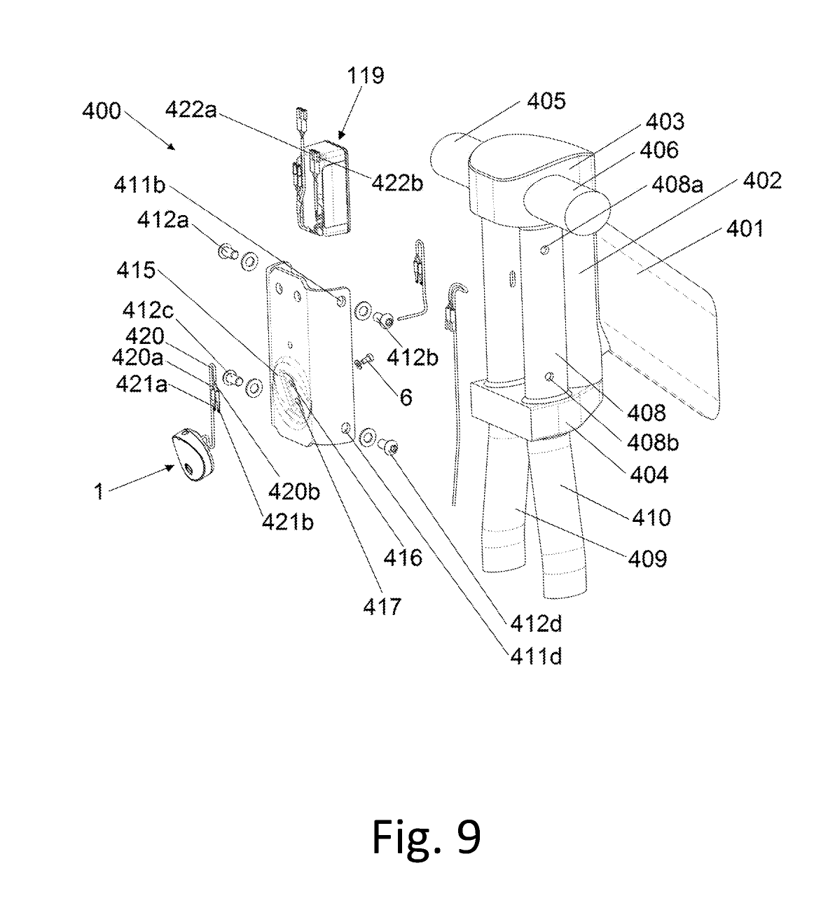

FIG. 1b is a rear perspective view of the laser projection device of FIG. 1a. A U-shaped attachment member 5 extends from an upper part of the rear of the housing 2 and a screw head 6 extends from a lower part of the rear of the housing 2. The screw head 6 and U-shaped attachment member 5 are used to attach the laser projection device 1 to a conventional bike front plate, as will be described later with respect to FIGS. 9-16

FIG. 1c is a front view of the laser projection device of FIG. 1a. A line A-A is shown, from which the cross-sectional view of FIG. 1f is taken.

FIG. 1d is a side view of the laser projection device of FIG. 1a. From this view, it can be seen to what extent the screw head 6 and U-shaped attachment member 5 extend from the rear of the housing 2. The extent of the curvature of the front surface of the housing 2, to which the reflective sticker 3 is attached, can also be seen.

FIG. 1e is a rear view of the laser projection device of FIG. 1a.

FIG. 1f is a cross-sectional view of the laser projection device 1 taken along line A-A in FIG. 1c. From this view, it can be seen that the components of the laser projection device 1 are arranged in a ‘periscope arrangement’, wherein a laser light source 8 is arranged perpendicularly to the aperture 4 through which the laser light ultimately exits the device. The periscope arrangement allows the depth of the device (the dimension indicated by Z in FIG. 1f) to be reduced when compared with conventional ‘linear’ laser projection devices. Typically, the dimension indicated by Z in FIG. 1f will be approximately 20 mm.

The laser light source 8 is located in a cylindrical cavity within the housing 2. The laser light source 8 is inserted through the cylindrical aperture 7 in the top of the device. After insertion, a small amount of silicone is injected into the cylindrical aperture 7 to seal to the cylindrical aperture 7 and prevent the laser light source 8 from passing back through.

In a lower part of the housing 2, a mirror 9 is held by a mirror holder 10. The mirror 9 is held in place, clamped between the mirror holder 10 and an intermediate piece 12. This arrangement will be described in more detail later. The intermediate piece 12 also bears against a diffractive optical element (DOE) 11 in use to retain it in a diffractive optical element (DOE) holder 13.

In use, the laser light source 8 produces a beam of laser light. Said beam is reflected off the surface of the mirror 9 and through the DOE 11. The DOE 11 contains an image (for example, a bicycle) which is transferred to the beam of laser light by way of optical interference. The modified laser light beam then passes through the aperture 4 and is projected onto a surface (for example, a road surface in front of, or behind, a bicycle to which the device is attached) approximately 3-5 metres away.

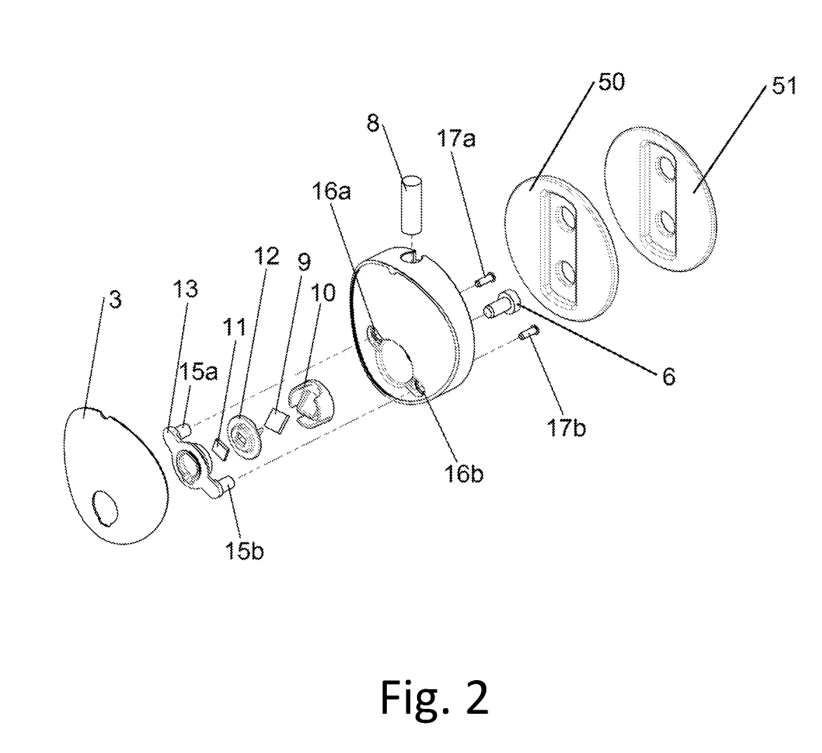

FIG. 2 is an exploded front perspective view of the laser projection device of FIG. 1a. From this view, it can be seen that the DOE holder 13 comprises a pair of arms 15a, 15b. The arms 15a, 15b extend through respective apertures 16a, 16b in the housing 2 and hollowed to receive respective self-tapping screws 17a, 17b. As the screws 17a, 17b are tightened in the arms 15a, 15b, the DOE holder 13 is drawn towards the housing 2. The DOE holder 13 then bears against the DOE 11, the intermediate piece 12, the mirror 9 and the mirror holder 10. An O-ring 18 (see FIG. 1f) ensures a tight and vibration-free seal between the intermediate piece 12, the DOE holder 13 and the housing 2.

When fully tightened, the entire stack of components 9-13 is securely held together. This is important for the operation of the laser projection device 1 for several reasons. Firstly, the mirror 9 and mirror holder 10 must be firmly held in the housing 2 at a specific angle. A small variation in the angle of the mirror 9 may result in a large deviation of the ultimate position of the projected laser image (and this is amplified the further away the image is projected). Similarly, the relative position of the DOE 11 and the laser light beam reflected from the mirror 9 must be held in a strict spatial arrangement in order for the image contained in the DOE 11 to be properly transferred to the laser light beam. Deviations in this position may result in only partial image transfer to the beam, and a partial projected image. Secondly, if one or more of the components 9-13 were to become loose within the housing 2, unmodified laser light from the laser light source 8 could escape the housing 2. This poses a safety risk, as a person looking directly into such laser light could suffer an eye injury.

The DOE 11 is roughly square in shape, and angled at approximately 25-30 degrees from horizontal. This is because in the specific embodiment, the DOE 11 has an image of a bicycle. As a bicycle requires more width than height, setting the square-shaped DOE 11 at an angle makes better use of the diagonal and allows the image of the bicycle to be made larger than if the square DOE 11 was set to be horizontal.

FIG. 2 also shows a pair of wedges 50, 51. These are optional components that may not be necessary in practice. Either or both of these may be inserted between the laser projection device 1 and a bicycle to which it is to be attached to adjust the angle of the laser projection device 1 with respect to the ground. This allows the projected laser image to be moved further from the bicycle. The wedges 50, 51 may be formed of a rubberised plastics material, for example a thermoplastic elastomer (TPE). Wedge 51 is designed to deflect the laser light image by approximately 1.5 degrees. Wedge 50 is slightly thicker than wedge 51, and is designed to deflect the angle of the laser light image by approximately 3 degrees. As the wedges 50, 51 are rubberised, they also perform a mild vibration-absorbing function.

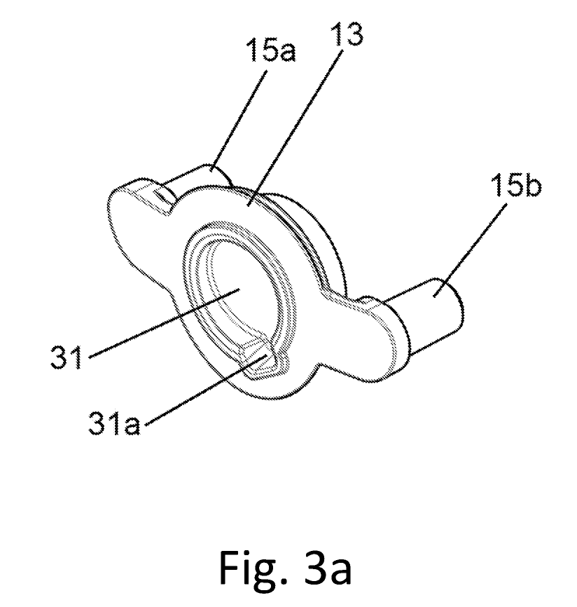

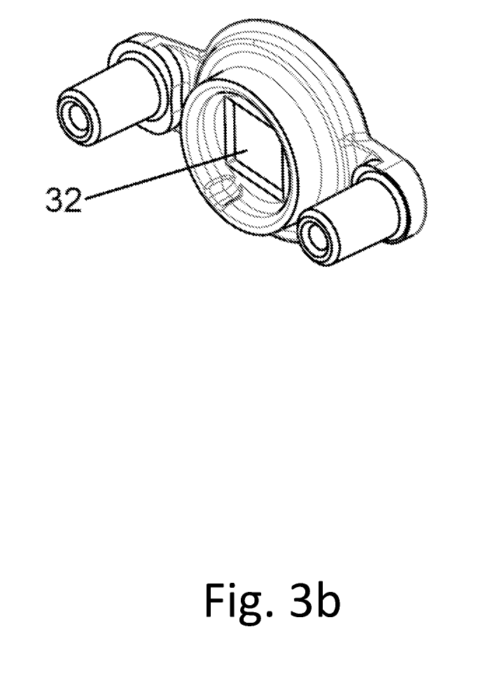

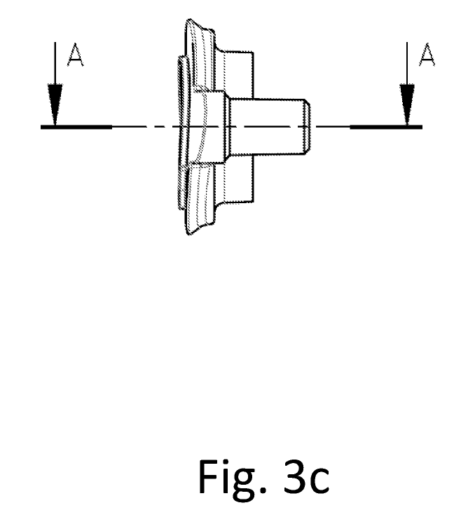

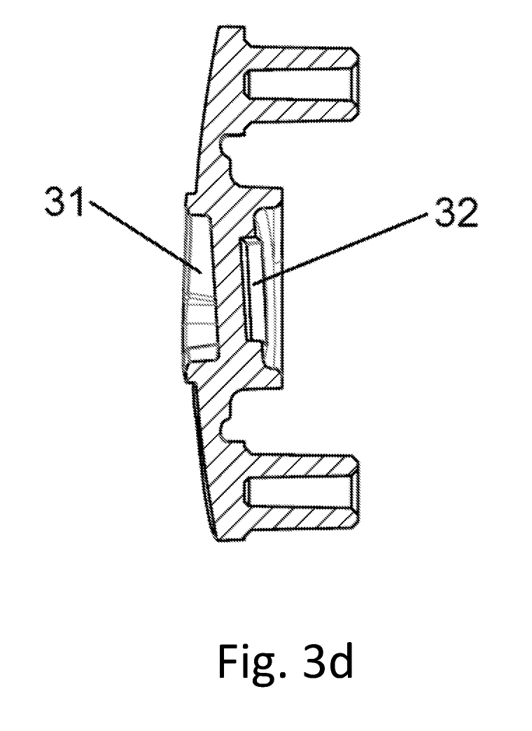

FIG. 3a is a front perspective view of the DOE holder 13 shown in FIG. 2. The DOE holder 13 is a unitary piece made of moulded plastic. Optically clear polycarbonate is a preferred material, as laser light must be able to pass through the DOE holder 13 in use. The DOE holder 13 comprises a central recess 31 with an offset portion 31a. The recess 31 allows the DOE holder 13 to be thinner in its central region, which maximizes laser light transmission therethrough.

FIG. 3b is a rear perspective view of the DOE holder 13 of FIG. 3a. From this view, a rear recess 32 of the DOE holder 13 may be seen. The rear recess is approximately square in shape, and dimensioned to receive a portion of a diffractive optical element (DOE) 11 for use with the laser projection device. In use, a portion of the DOE 11 is received in the rear recess 32. The walls of the rear recess 32 prevent the DOE 11 from rotating, and, as the rear recess 32 is dimensioned to receive the DOE 11 in a snug fit, the DOE 11 is held in a vibration-free manner.

FIG. 3c is a side view of the DOE 13 holder of FIG. 3a. A line A-A is shown, from which the cross-sectional view of FIG. 3d is taken.

FIG. 3d is a cross-sectional view of the DOE holder taken across the line A-A in FIG. 3c. From this view the unitary moulding can be easily seen, as the DOE holder 13 is the same material throughout.

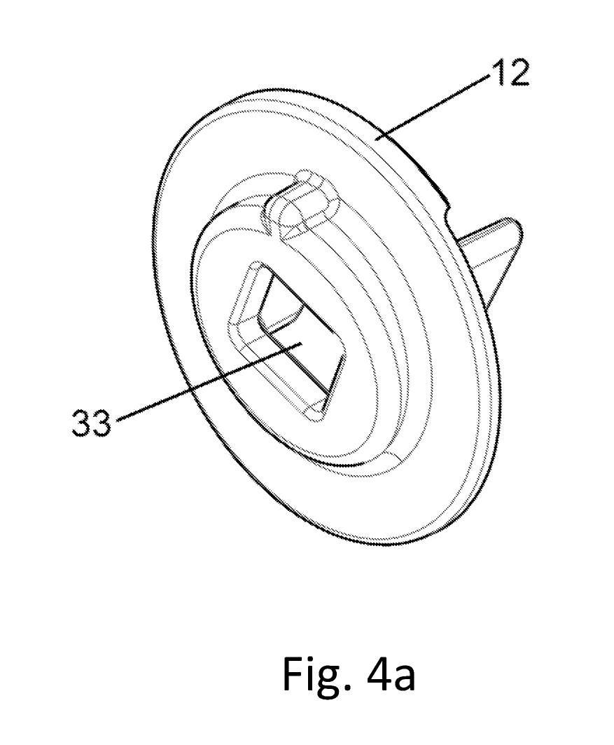

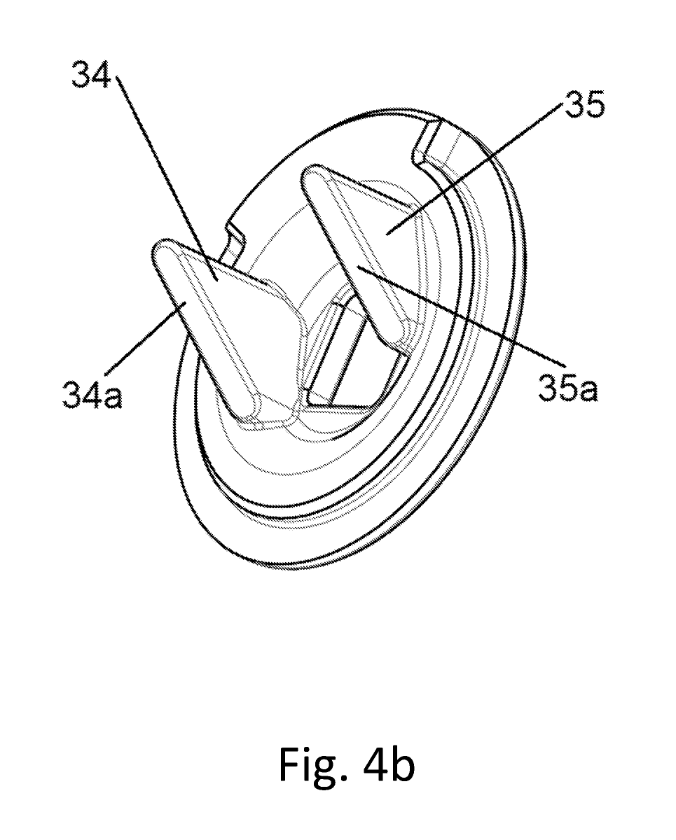

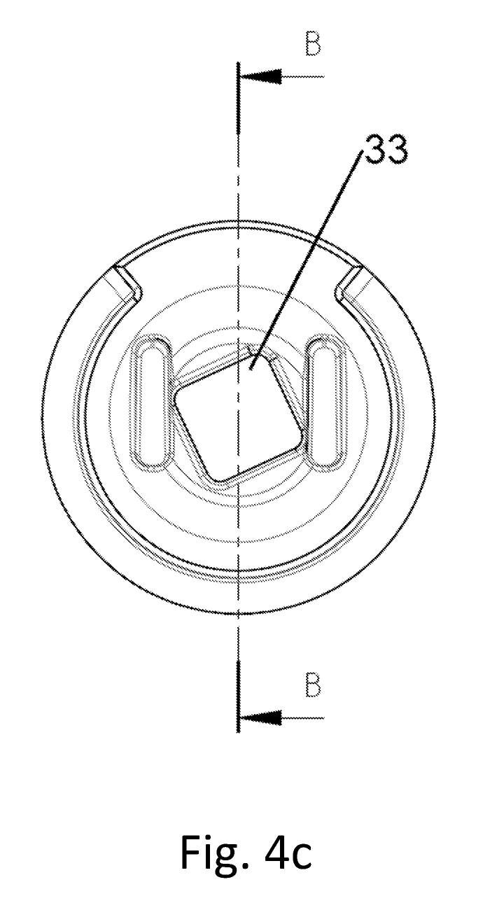

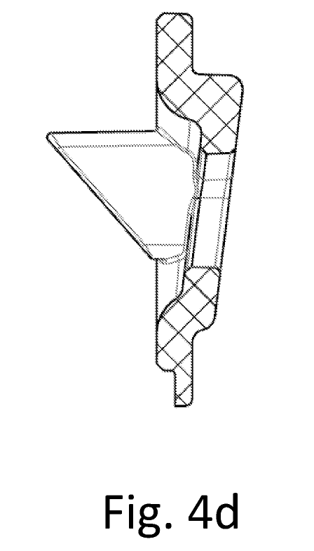

FIG. 4a is a front perspective view of the intermediate piece 12 shown in FIG. 2. The intermediate piece 12 comprises a front aperture 33. The front aperture 33 is approximately square in shape, and allows laser light to pass through. When the stack of components 9-13 are drawn towards one another, as described above, the DOE 11 is tightly held in the rear recess 32 of the DOE holder 13 by a front surface of the intermediate piece 12.

FIG. 4b is a rear perspective view of the intermediate piece 12 of FIG. 4a. From this view, it can be seen that the intermediate piece 12 comprises a pair of projecting arms 34, 35. Each projecting arm 34, 35, comprises a respective angled portion 34a, 35a.

FIG. 4c is a rear view of the intermediate piece 12 of FIG. 4a. A line B-B is shown, from which the cross-sectional view of FIG. 4d is taken.

FIG. 4d is a cross-sectional view of the intermediate piece 12 taken across the line B-B in FIG. 4c.

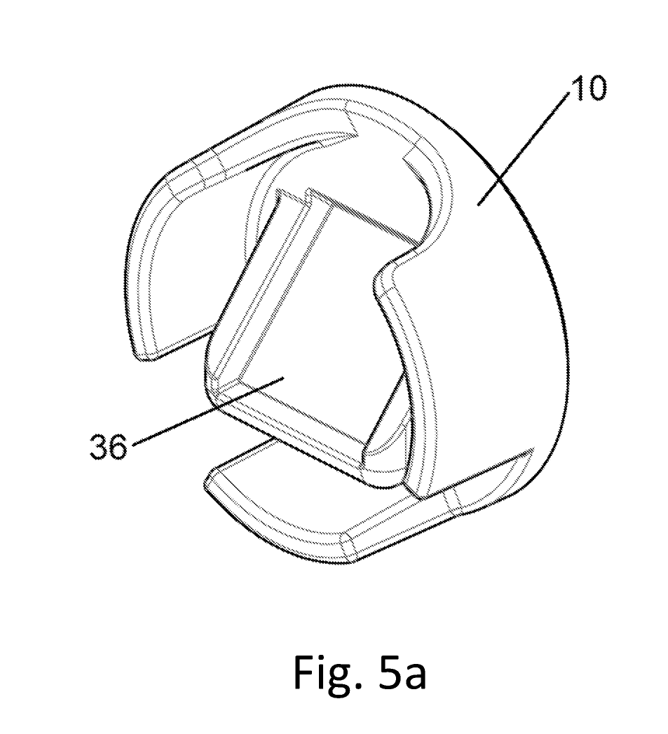

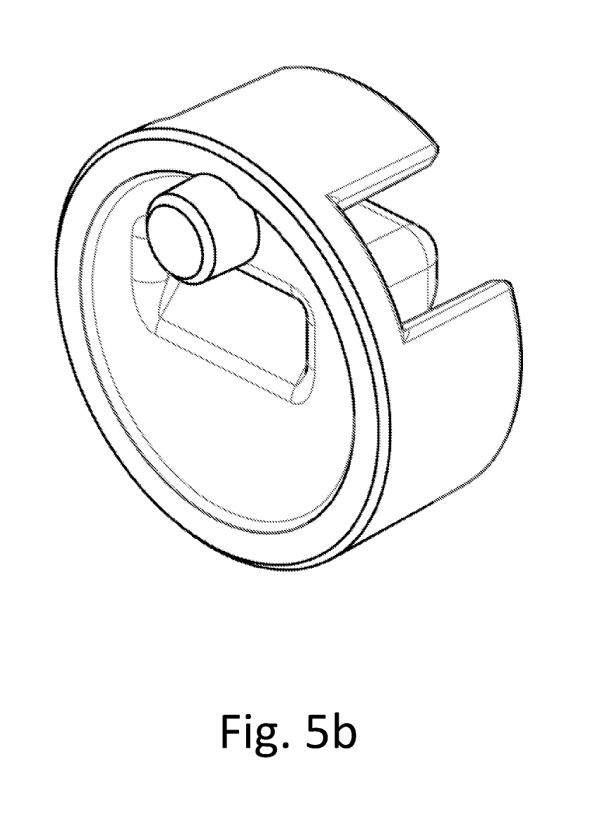

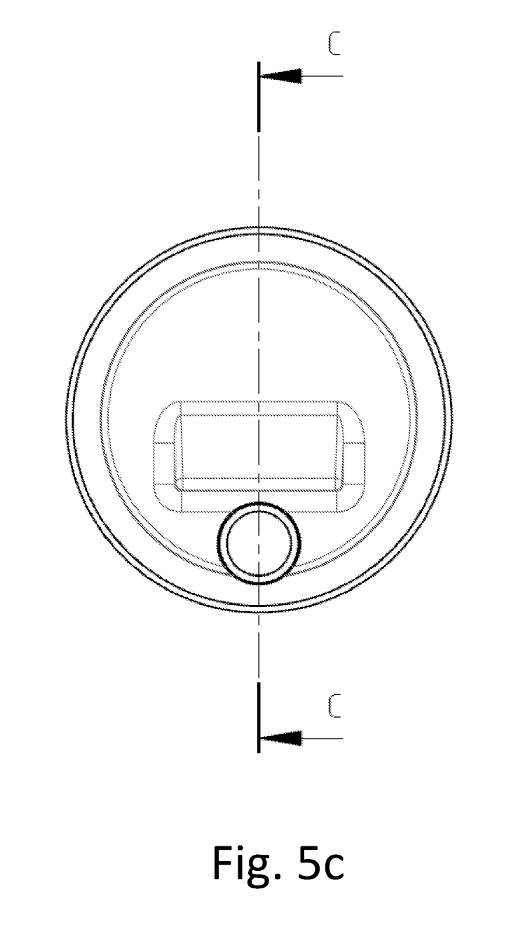

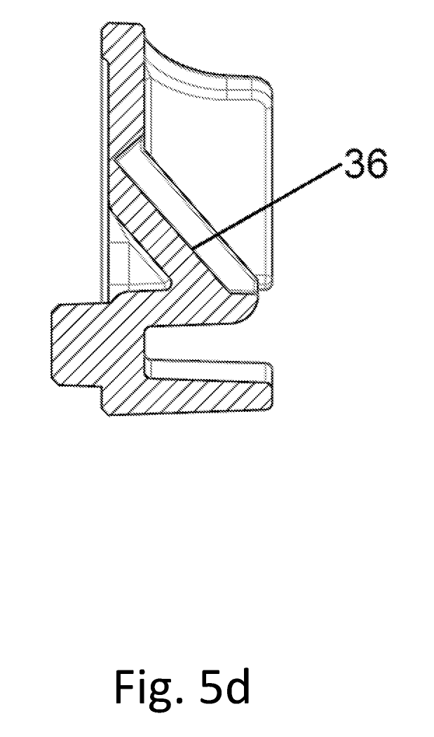

FIG. 5a is a front perspective view of the mirror holder 10 shown in FIG. 2. The mirror holder 10 comprises an angled seat 36 which is dimensioned to receive the mirror 9 in use, and to hold the mirror 9 at the appropriate angle to reflect a beam of laser light from the laser light source 8 though the DOE 11. In use, when the stack of components 9-13 are drawn towards one another, as described above, the angled portions 34a, 35a of the projecting arms 34, 35 of the intermediate piece 12 press the peripheral side portions of the mirror 9 firmly into the angled seat 36 of the mirror holder 10 and so hold it firmly in place in a vibration- and rotation-free manner.

FIG. 5b is a rear perspective view of the mirror holder of FIG. 5a.

FIG. 5c is a rear view of the mirror holder of FIG. 5a. A line C-C is shown, from which the cross-sectional view of FIG. 5d is taken.

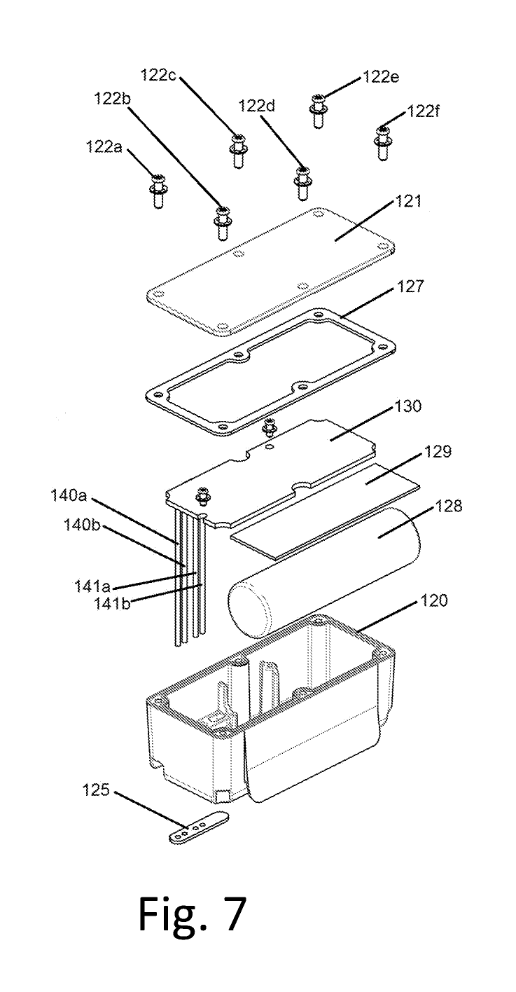

FIG. 5d is a cross-sectional view of the mirror holder taken across the line C-C in FIG. 7c.

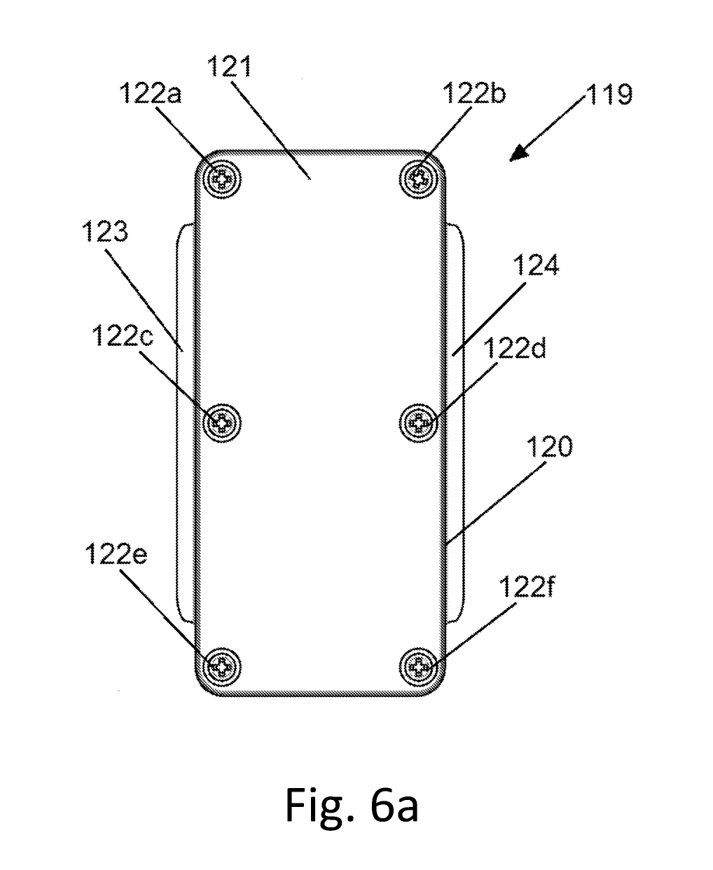

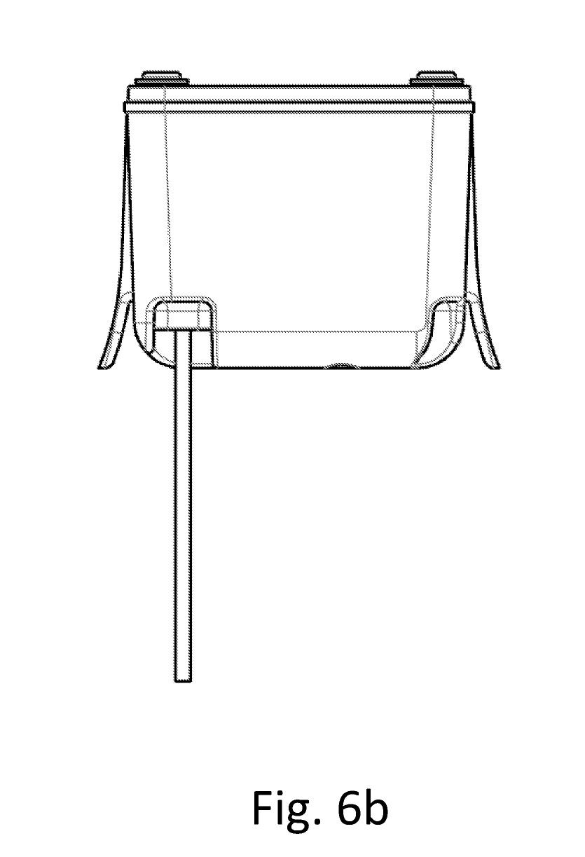

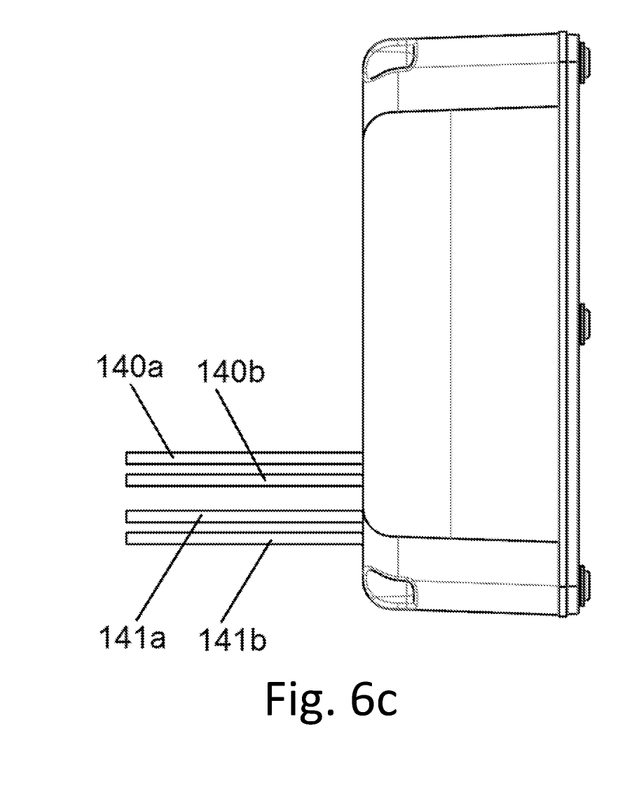

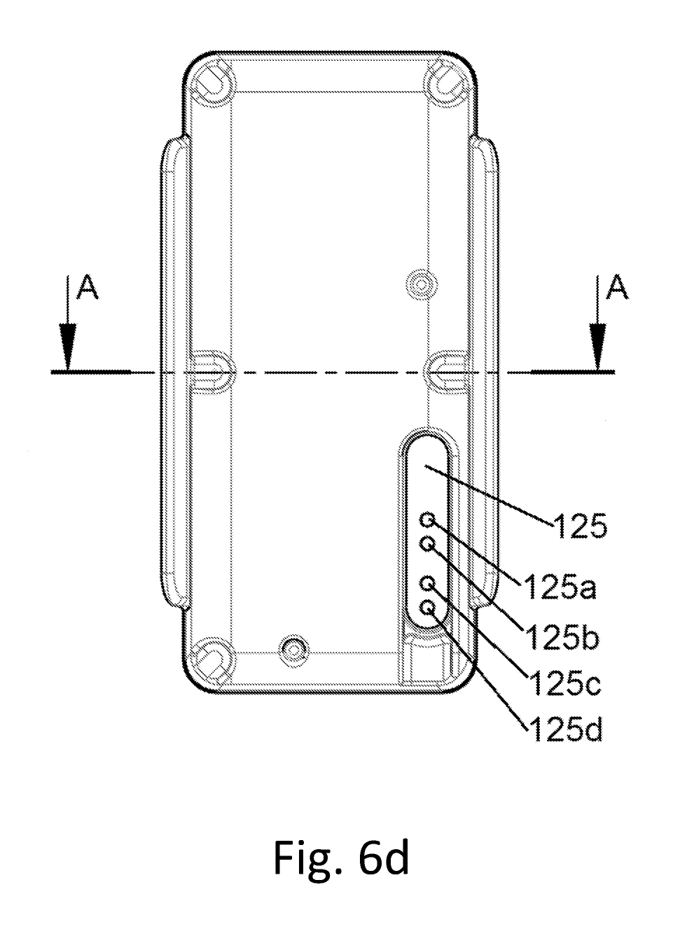

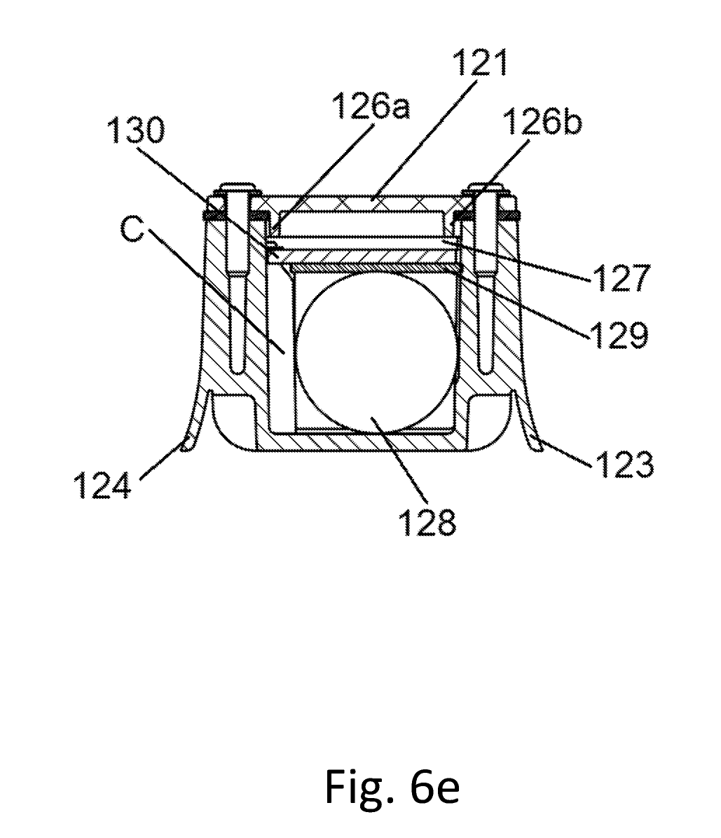

FIG. 6a is a rear view of a power unit 119 suitable for use with the laser projection device 1 of FIGS. 1-2. The power unit 119 comprises a housing 120. An outer plate 121 is attached to the housing 120 via six screws 122a-f. The housing 120 and outer plate 121 together form a cavity C (see FIG. 6e) which houses the electrical components of the power unit 119. The outer plate 121 can, for example, be laser cut or moulded from a plastics material. Moulding generally results in a better fit of the outer plate 121 with the housing 120.

The power unit 119 also comprises a pair of flaps 123, 124. These extend from the housing 120 and are resiliently biased outwardly from the housing 120. In use the flaps 123, 124 bear against a pair of uprights on a bicycle (typically the uprights between the frame and the handlebars) to secure the power unit 119 in place.

FIG. 6b is a bottom view of the power unit 119 of FIG. 6a. It can be seen from this view that a plurality of wires protrude from a lower front section of the housing 120.

FIG. 6c is a side view of the power unit 119 of FIG. 6a. From this view it can be seen that the plurality of wires comprises four wires 140a, 140b, 141a and 141b. In use, the first pair of wires 140a, 140b is connected to the laser projection device 1 to supply electrical power thereto, and the second pair of wires 141a, 141b is connected to a dynamo on a bicycle to receive electrical power therefrom.

FIG. 6d is a front view of the power unit 119 of FIG. 6a. A line A-A is shown, from which the cross-sectional view of FIG. 6e is taken. From this view, a rubber seal 125 can be seen. The rubber seal 125 comprises four apertures 125a-d, through which the plurality of wires 140a, 140b, 141a, 141b pass in use. The housing 120 comprises through-holes corresponding to apertures 125a-d, which allow the plurality of wires 125 to pass from the interior of the internal cavity C to the exterior of the power unit 119. The rubber seal 125 acts to retain the plurality of wires 140a, 140b, 141a, 141b in position, and to prevent water or dirt from entering the internal cavity C of the power unit 119. To improve the seal, silicone

FIG. 6e is a cross-sectional view of the power unit taken across line A-A in FIG. 6d. From this view it can be seen that the outer plate 121 comprises a pair of projecting ribs 126a, 126b. The projecting ribs contact a cover seal 127 which creates an air- and fluid-tight seal between in the internal cavity C of the power unit 119 and the external environment in use.

The internal cavity C contains a lithium-ion cell 28 and a printed circuit board (PCB) 130. A piece of insulating foam 129 is located between the cell 128 and the PCB 130.

FIG. 7 is an exploded perspective view of the power unit of FIG. 6a. This view more clearly illustrates how each of the various components 120-130 fit together in practice.

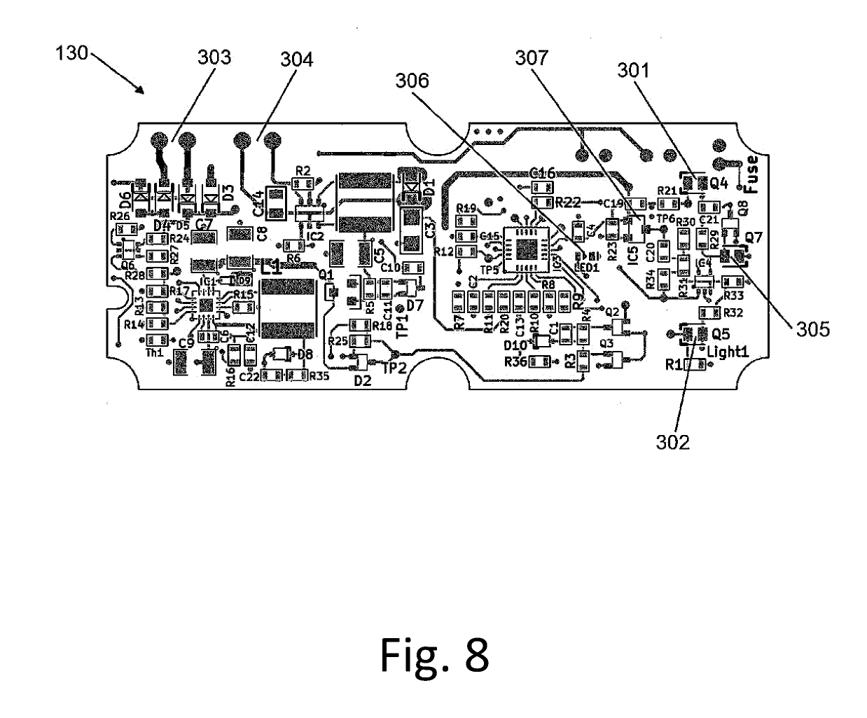

FIG. 8 schematically shows the printed circuit board 130 in more detail. A first ambient light sensor 301 and a second ambient light sensor 302 are located on the PCB 130. Also shown on the PCB 130 is a power input 303, which is connected to a dynamo via a pair of the wires 141a, 141b in use, and a power output 304, which is connected to the laser light source 8 in the laser projection device 1 via a pair of the wires 140a, 140b in use. The PCB 130 comprises an infrared sensor 305, which acts as an optical interface for the transfer of data to or from the PCB 130, and a red LED 306. The PCB 130 also comprises a microcontroller 307.

When assembled, the ambient light sensors 301, 302 are located internally to the power unit 119, and the outer plate 121 and cover seal 127 are made of transparent materials that allow the ambient light exterior to the power unit 119 to be measured by the ambient light sensor 301, 302 located within the power unit 119. This is a particularly effective arrangement, as locating the light sensors 301, 302 within the power unit 119 prevents them from being damaged. Light sensors located on the exposed exterior of the power unit would be vulnerable to being damaged, for example, in a collision with another object.

The light sensors 301, 302 monitor the ambient light level, and transmit this information to the microcontroller 307. In response, the microcontroller 307 controls the laser projection device 1 to turn on (if the detected light level is below a predetermined threshold) and off (if the ambient light level is above a predetermined threshold).

If the ambient light level is high, for example in daylight, the required intensity of light that the laser light source 8 would need to produce to create a visible image would be hazardous to the unprotected human eye. Therefore, it is only effective to turn on the laser projection device 1 when the light level is sufficiently low for a relatively low intensity (e.g. class of projected laser image to be visible, and the predetermined threshold for the laser projection device 1 to turn on is set to this light level.

The light level for the laser projection device 1 to turn off, once it is on, is set significantly higher than the ‘turn on’ light level. This is to prevent the laser projection device from rapidly turning on and off when the ambient light level is close to the turn on light level. The microcontroller 307 is also programmed to have a time-delay between the measured light level crossing a threshold, and sending a control signal to the laser projection device 1. This is to prevent the laser projection device 1 from turning on or off due to a temporary obstruction to the ambient light sensors, such as a shadow.

FIG. 9 shows exploded perspective view of a bicycle frame 400 to which the laser projection device of FIGS. 1-2 and the power unit of FIGS. 5-6 may be attached. The bicycle frame 400 comprises a main body member 401 having an upright portion 402. The upright portion 402 is pivotally engaged with an upper hub 403 and a lower hub 404. First and second handlebars 405, 406 protrude laterally from the upper hub 403 and a user of the bicycle grips these to steer the bicycle in use, as is well known in the art.

A pair of uprights 407, 408 project downwardly from the upper hub 403. The uprights 407, 408 pass through the lower hub 404 and splay outwards to form the forks 409, 410. These have attachment means (not shown) for a front wheel of the bicycle, as is also well known in the art.

In use, the laser projection device 1 is attached to a front plate 411 of the bicycle frame 400. The front plate 411 is a typically formed of a stamped piece of metal. The front plate 411 has four through-holes 411a-d which are dimensioned to receive screws. Only through-holes 411b and 411d are visible in the view of FIG. 9, however through-holes 411a and 411c are correspondingly positioned on the opposite side.

In use, a pair of screws 412b, 412d are passed through the through-holes 411b and 411d and are received in threaded holes 408a and 408b in the upright 408. Similarly, a pair of screws 412a, 412c are passed through through-holes 411a and 411c and are received in threaded holes (not shown) in the upright 407 to secure the front plate 411 to the uprights 407, 408.

The front plate 411 comprises an attachment portion 415. The attachment portion is angled downward, so that any laser light emitted by an attached laser projection device 1 is directed towards the ground. The attachment portion comprises a pair of apertures: an upper aperture 416 and a lower aperture 417. The upper aperture 416 allows a wire 420 from the laser projection device 1 to pass through the front plate 411. The lower aperture 417 is positioned so that a screw 6 (which corresponds to screw 6 shown in FIGS. 1b and 1f) may pass through the front plate 411 from behind to be received in a corresponding threaded aperture in the rear of the laser projection device 1 and so secure the laser projection device 1 to the front plate 411.

The wire 420 actually comprises a pair of twisted wires 420a, 420b contained in an outer insulation. At the end of the wire 420 the twisted wires 420a, 420b separate out and terminate in respective male connectors 421a, 421b. These may be attached to female connectors 422a, 422b attached to the ends of the pair of wires 140a, 140b which are connected to the power unit 119.

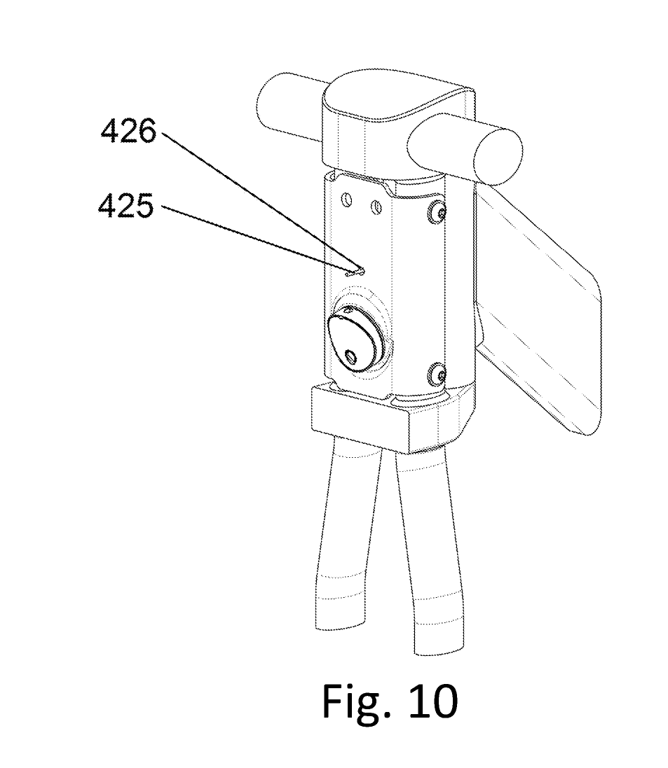

A completely attached laser projection device 1 and front plate 411 is shown in FIG. 10. As the laser projection device 1 presents an identical rear aspect to a standard circular bike reflector (by virtue of the ‘periscope’ arrangement of the laser light source 8 and mirror 9), the laser projection device 1 of the present invention may be attached to standard front plates which have existing apertures for the attachment of reflectors.

A wire 425 can be seen protruding through an aperture 426 in the front plate 411. This wire connects the dynamo to supercapacitors (not shown) which power pre-existing LED lighting (not shown) on the bicycle frame 400.

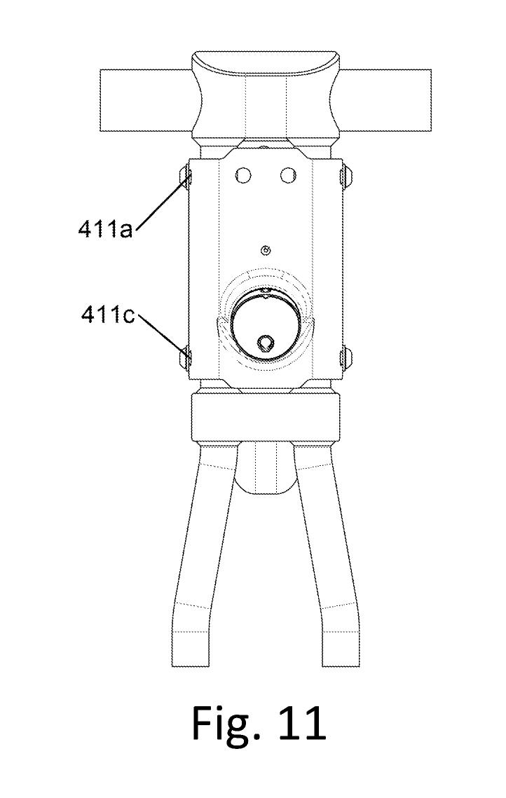

FIG. 11 shows a front view of the completely attached laser projection device 1 and front plate 411 of FIG. 10. In this view apertures 411a and 411c, which were obscured in FIG. 9, are visible.

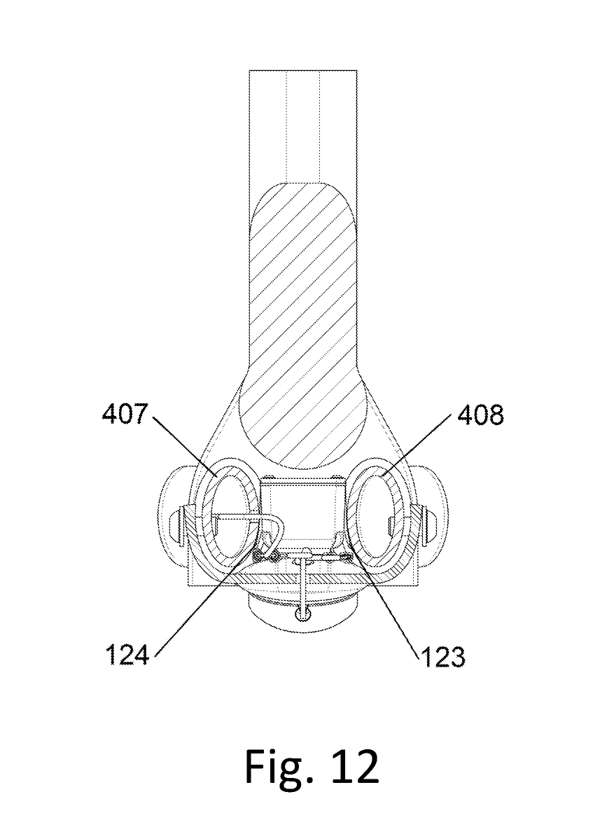

FIG. 12 shows the completely attached laser projection device 1 and front plate 411 of FIG. 10 viewed from above in cross-section. From this view it can be seen that the power unit 119 is situated behind the front plate 411. The power unit 119 is held in place by the pair of outwardly biased flaps 123 and 124, which resiliently bear against the uprights 408 and 407 respectively.

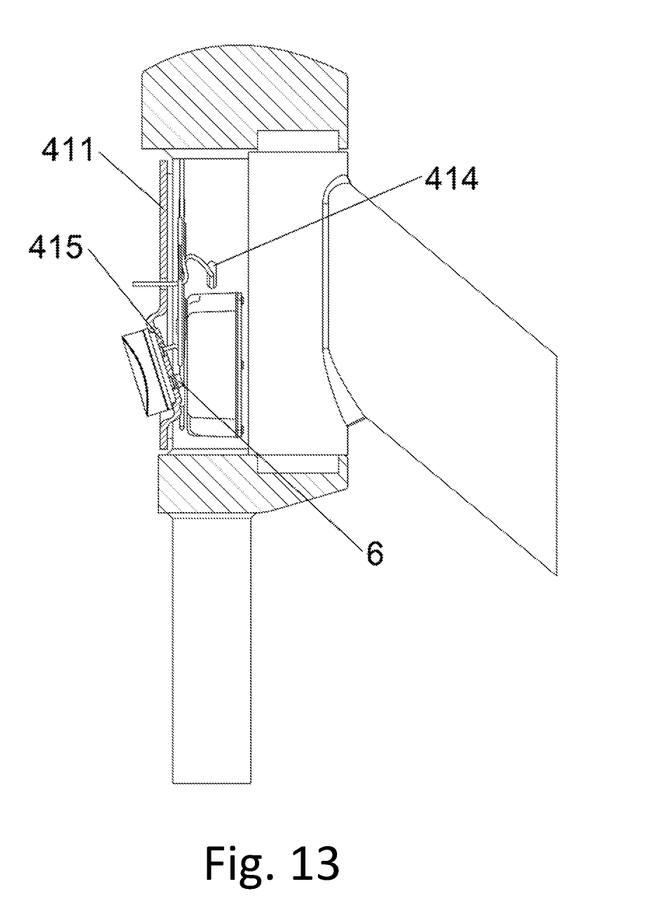

FIG. 13 shows the completely attached laser projection device 1 and front plate 411 of FIG. 10 viewed from the side in cross-section. From this view it can be seen that the attachment portion 415 of the front plate 411 conforms in shape to the rear of the laser projection device 1. This gives the laser projection device a snug fit when attached, which limits movement in all lateral directions, and the periphery of the attachment portion extends in a lip around the circumference of the rear of the laser projection device 1, which makes it difficult for thieves or vandals to access the screw 6 to remove the laser projection device 6 from the front plate 411.

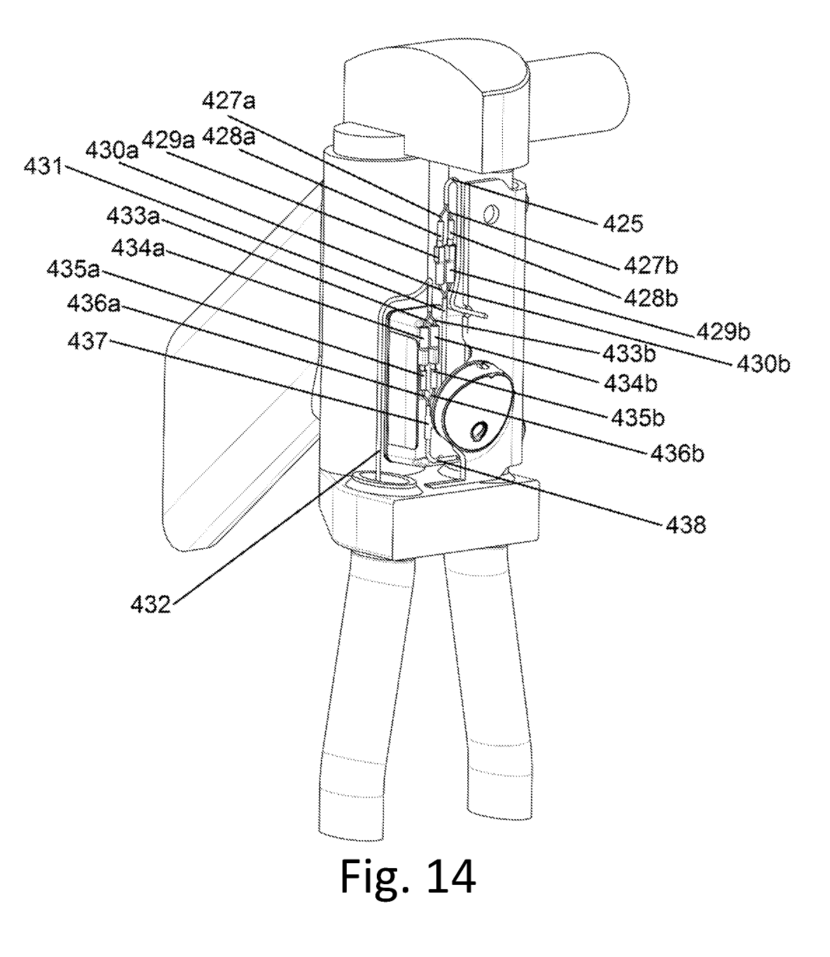

FIG. 14 shows the completely attached laser projection device 1 and front plate 411 of FIG. 10 viewed from a front perspective view with a partial cut-away. In this view it can be seen how the laser projection device 1 and power unit 119 may be retrofitted into existing circuitry on a bicycle.

The wire 425, which leads from supercapacitors that power pre-existing LED lighting on the bicycle frame 400, enters the front plate 411. The wire 425 comprises a pair of wires 427a, 427b contained in an outer insulation. The pair of wires 427a, 427b terminate in respective male connectors 428a, 428b.

A wire 432 leading from a hub dynamo on the bicycle frame 400 enters the area behind the front plate 411 through a window 414 in the upright 407 (see FIG. 13). The wire 432 comprises a pair of wires 433a, 433b contained in an outer insulation. The pair of wires 433a, 433b terminate in respective female connectors 434a, 434b.

In a standard configuration, before a retrofit operation has been performed, the male connectors 428a, 428b would be connected to the female connectors 434a, 434b. In this configuration supercapacitors are directly charged by the hub dynamo.

To perform the retrofit operation, the male connectors 428a, 428b are disconnected from the female connectors 434a, 434b. The male connectors 428a, 428b are then connected to respective female connectors 429a, 429b. The female connectors 429a, 429b are the terminal ends of wires 430a, 430b. The wires 430a, 430b lead into wire 431, which provides an outer insulation for the wires 430a, 430b.

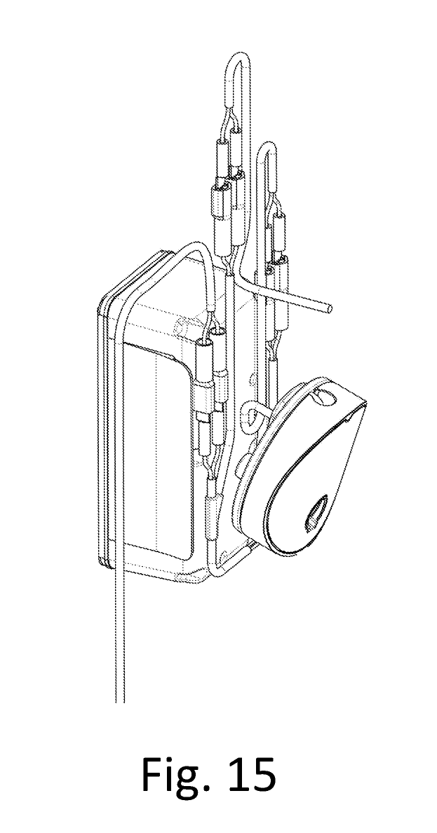

The female connectors 434a, 434b are connected to respective male connectors 435a, 435b, which comprise the terminal ends of wires 436a, 436b. The wires 436a, 436b and the wires 430a, 430b combine within the junction piece 437. This can be more clearly seen in FIG. 15.

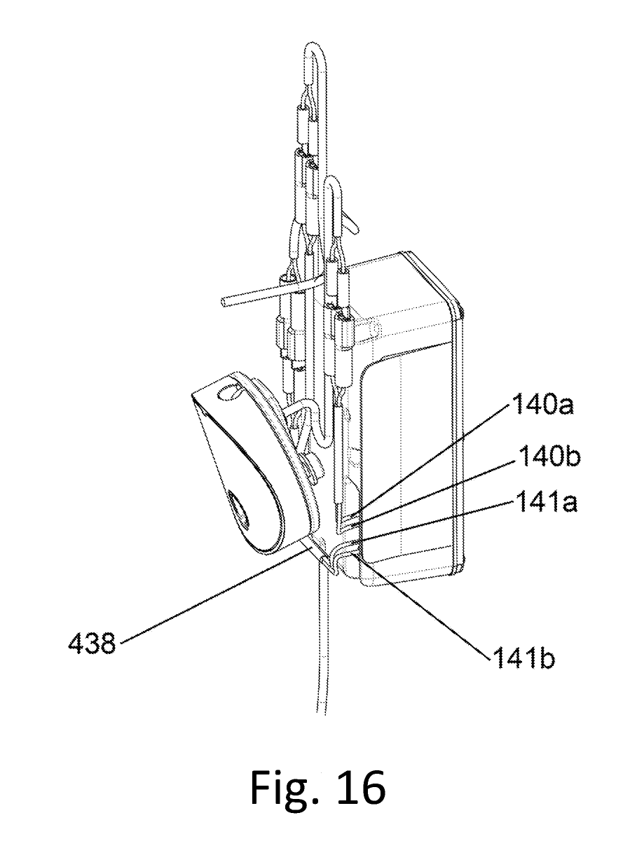

Once the wires 436a, 436b and the wires 430a, 430b have been combined they continue within wire 438 and connect to the power unit 119 as wires 141a, 141b (see FIG. 6c and FIG. 16).

FIG. 15 shows the circuitry connecting the laser projection device 1 to the power unit 119. It shows a similar view to FIG. 14, but with the uprights 407, 408, front plate 411 and reference numerals removed for clarity.

FIG. 16 shows the circuitry connecting the laser projection device 1 to the power unit 119. The view is taken on the opposite side to that shown in FIG. 15 to more clearly show how the wires 140a, 140b, 141a and 141b enter the power unit 119.

Programming the PCB

On the PCB 130, the infrared receiver 305 is connected to a universal synchronous/asynchronous receiver/transmitter (USART) pin on the PCB 130. Data can be transferred to the PCB 130 using an adaptor (not shown) which is configured to transmit serial optical data.

Said optical data is received by the infrared receiver 305 which feeds the data to the USART receiver pin on the PCB 130. A corresponding transmitter pin on the PCB 130 controls a visible red LED 306 which serves a dual purpose of providing a visual indication that the system is working, and also serves as a serial data output. Said serial data output can be read by the adaptor, and can be used to download data stored on the PCB 130. For example, distance travelled information, which may be derived from the power unit's connection to a dynamo on a bicycle (described below).

The adaptor comprises an infrared receiver and receiver circuitry similar to the PCB 130. The adaptor comprises a data output cable which includes transistor-transistor logic (TTL) to universal serial bus (USB) convertor. This allows the adaptor to be connected to a standard PC. Custom software on the PC can be used to analyse data received by the adaptor, and to input setting changes to the adaptor to be transmitted to the PCB 130. Examples of setting changes include length of time the laser projector remains on after the bicycle stops moving, number of flashes/frequency of flashes of laser image after the bicycle stops moving, ambient light levels to trigger laser image on/off, etc.

Using Dynamo Power Waveform as Input for an Odometer

Most conventional dynamos are suitable for use with the present invention. An example would be a Shimano® hub dynamo, such as a DH-3R30 or DH-3R35, and these are often already installed on rental bicycles.

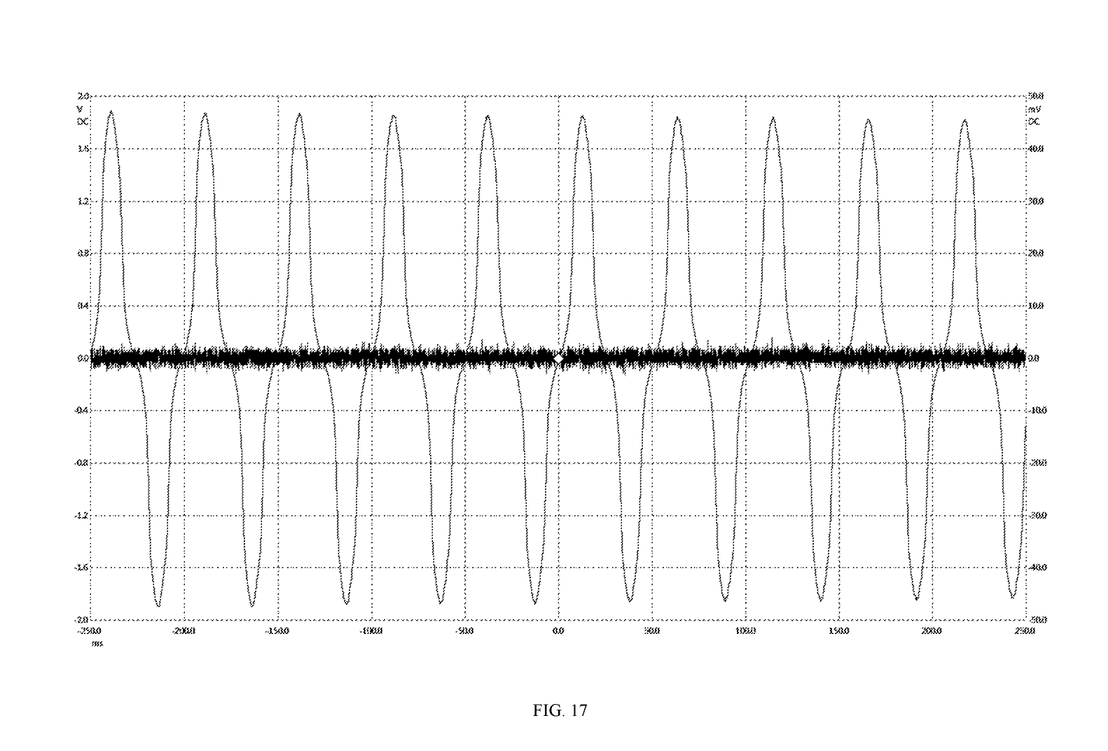

The cell 128 (for example, a rechargeable lithium-ion cell) can be charged using a wired connection from a dynamo on a bicycle (not shown) to the power input 303. A typical dynamo which is often used to charge existing LED lighting on rental bicycle generates an alternating current. Consequently, its output voltage passes through zero twice per cycle. An exemplary waveform produced by a bicycle dynamo without any load on a bicycle moving at a constant speed is shown in FIG. 17. The waveform can be approximated to an AC sine wave.

For each complete revolution of the wheel, the dynamo will inherently generate the same number of cycles. From the number of zero-crossings, the number of cycles can be determined, and from the number of cycles the number of revolutions of the wheel can be calculated. As the circumference of the wheel is consistent across a range of rental bicycles, this information is defined in the PCB firmware to allow calculation of the distance travelled from the number of cycles recorded.

The PCB 130 comprises a circuit which produces a logic pulse each time the voltage changes from positive to negative or from negative to positive. These logic pulses are counted by the microcontroller 307. The number of logic pulses approximately corresponds to the number of zero-crossings, and so from the number of logic pulses an approximate distance can be calculated.

Consequently, there is provided a method of measuring the approximate distance travelled by a bicycle in a given time, the bicycle having a dynamo, the method comprising the steps of:
measuring the electrical output of the dynamo over the given time;
producing a logic pulse each time the voltage of the electrical output is measured to change from positive to negative or from negative to positive;
counting the number of logic pulses produced over the given time;
inferring, from the number of logic pulses, the number of revolutions of the bicycle wheel over the given time; and
calculating, from the inferred number of revolutions, the distance travelled by the bicycle.

There is also provided an apparatus for performing the above method.

Intelligent Charging Regime

The power unit 119 may be connected to a dynamo on a bicycle which is already used to power pre-existing LED lighting on the bicycle. Typically, such lighting incorporates supercapacitors which are incorporated to store energy to power the lighting when the bicycle is not moving. Often the supercapacitors are configured to power the lighting at a reduced intensity for periods when the bike is stationary, for example at a junction. To charge the supercapacitors, the bike must be moving for a period of time (said time depending somewhat on the speed of the bike). It is strongly preferable that the laser power unit 119 should not lengthen this time.

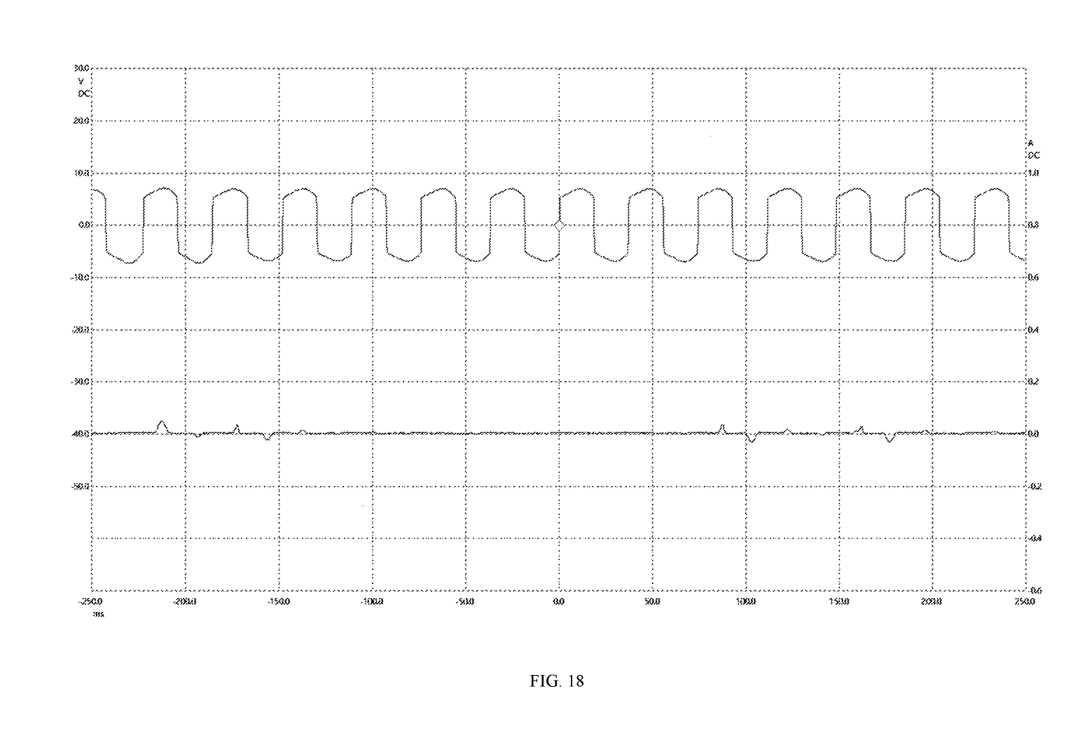

On the London-based ‘Boris Bikes’, for example, the voltage output from the dynamo is limited while the supercapacitors are charging, and so the power unit 119 is configured to draw a negligible current at this voltage. This is illustrated by FIG. 18, where the top trace shows the voltage waveform from the dynamo and the lower trace shows the current drawn by the power unit 119. During this period, if the laser is operating, it is powered by the stored energy in the cell 128.

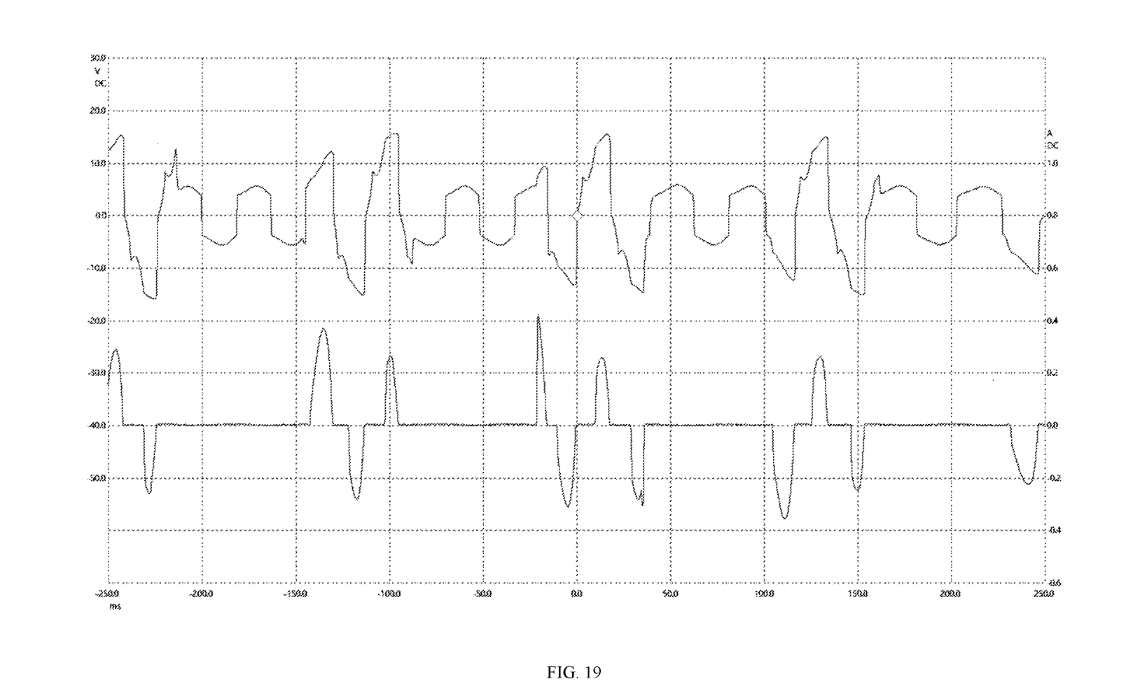

When the bike has just started to move, while the supercapacitors are not charged, or continuing to move when the supercapacitors are nearing full charge, supercapacitor charge current is not drawn on every cycle of the dynamo output. This is illustrated in FIG. 19, which shows the power unit 119 charging its cell 128 only during the periods when the power is not being supplied to the supercapacitors. In this way, interference to the power being supplied by the dynamo to the pre-existing LED lighting is avoided.

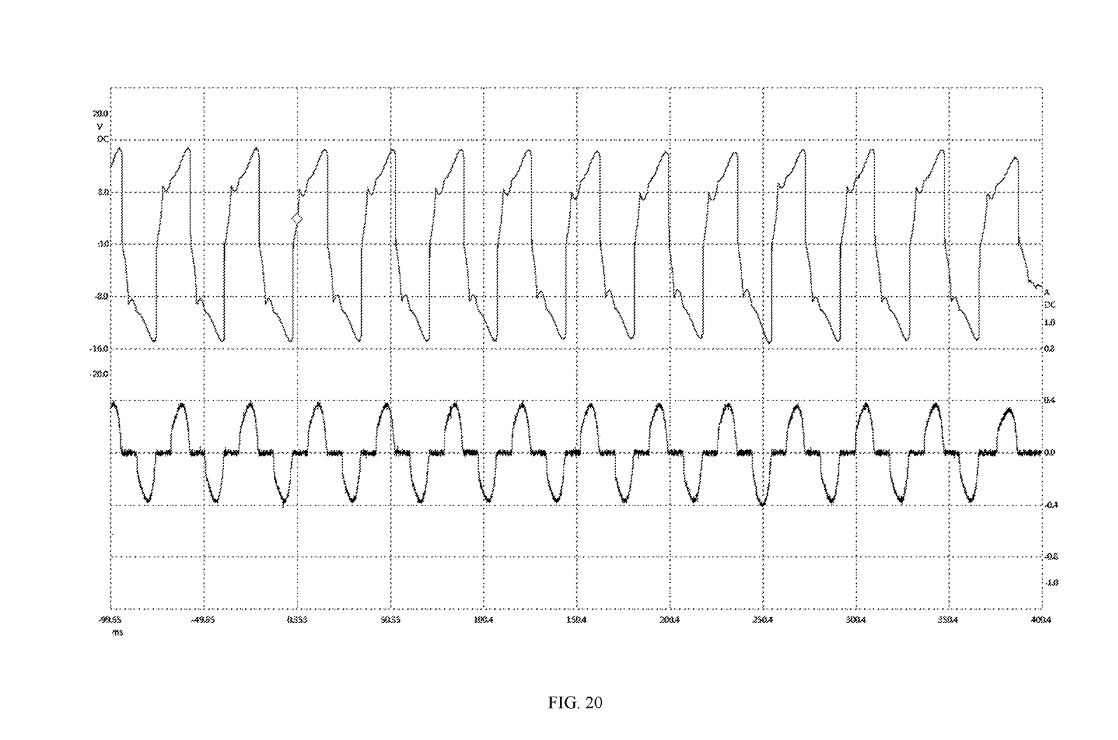

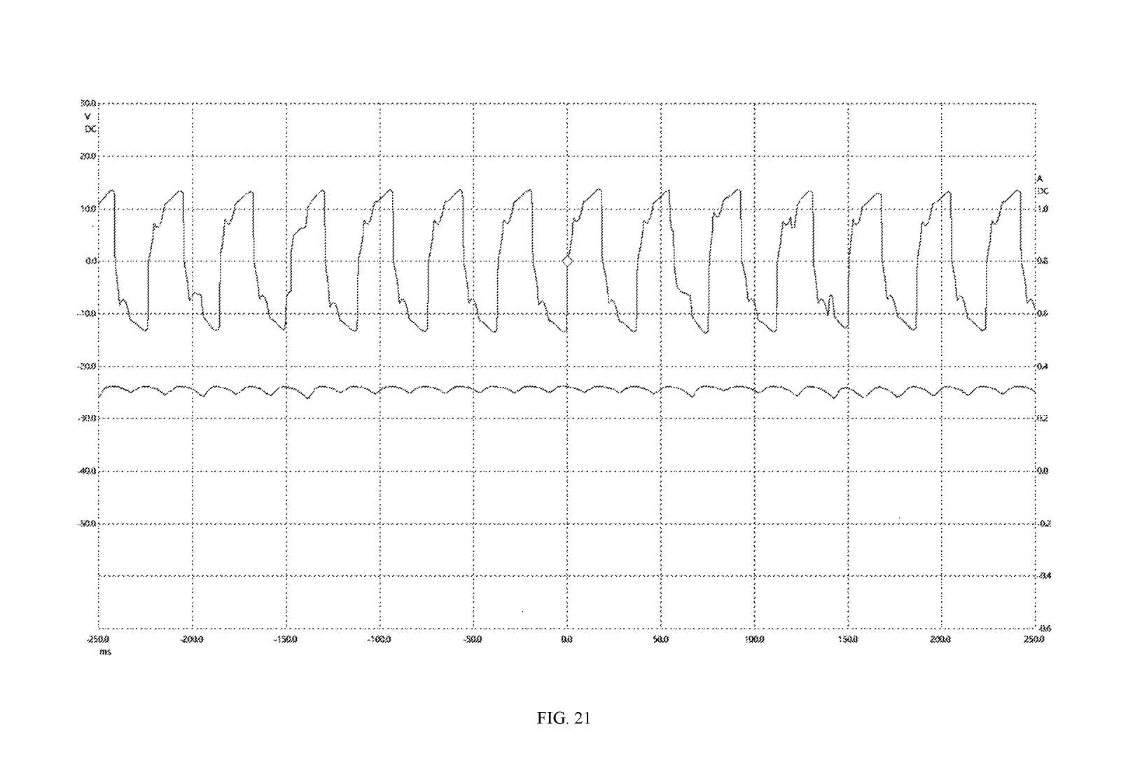

When the supercapacitors are fully charged, if the bike continues to move, only the continual operating power of the LED lighting draws power from the dynamo, and the remaining power is available to charge the cell 128 on every cycle. The waveform of FIG. 20 illustrates this situation, with dynamo voltage shown on the top trace and current drawn from the dynamo by the power unit 119 on the bottom trace. FIG. 21 shows the dynamo voltage on the top trace and the cell 128 charge current on the bottom trace, under the same conditions.

In this particular implementation, the dynamo output is used to charge bulk storage capacitors via a bridge rectifier. The resulting DC voltage is converted to the correct voltage to charge the cell 128 by means of a switched mode buck regulator. This makes more efficient use of the available power than would be provided by a linear charge circuit, because the typical DC voltage on the capacitors when the bike is travelling at a relatively high speed is normally between double and quadruple the voltage of a typical lithium-ion cell. Ignoring losses in the circuit, with 12V on the bulk storage capacitors and the cell 128 at 4V, the charge current of the cell 128 is typically three times the current drawn from the bulk storage capacitors.

The charge circuit adjusts the charge current relative to the voltage on the bulk storage capacitors, so that more power is drawn when the voltage is higher (which indicates that more power is available).

More charge current can be supplied, and consequently a higher efficiency may be achieved, by employing a power factor corrector circuit. This is a commonly-known type of circuit often used on AC mains power supplies. Using such a circuit, the instantaneous current drawn from the dynamo by the power unit 119 would follow the voltage waveform, with the exception that it would still be designed to draw negligible current at voltages which indicate that the supercapacitors are being charged. Such a system could apply the maximum power transfer theorem to use all the power available from the dynamo.

Control of Laser Voltage

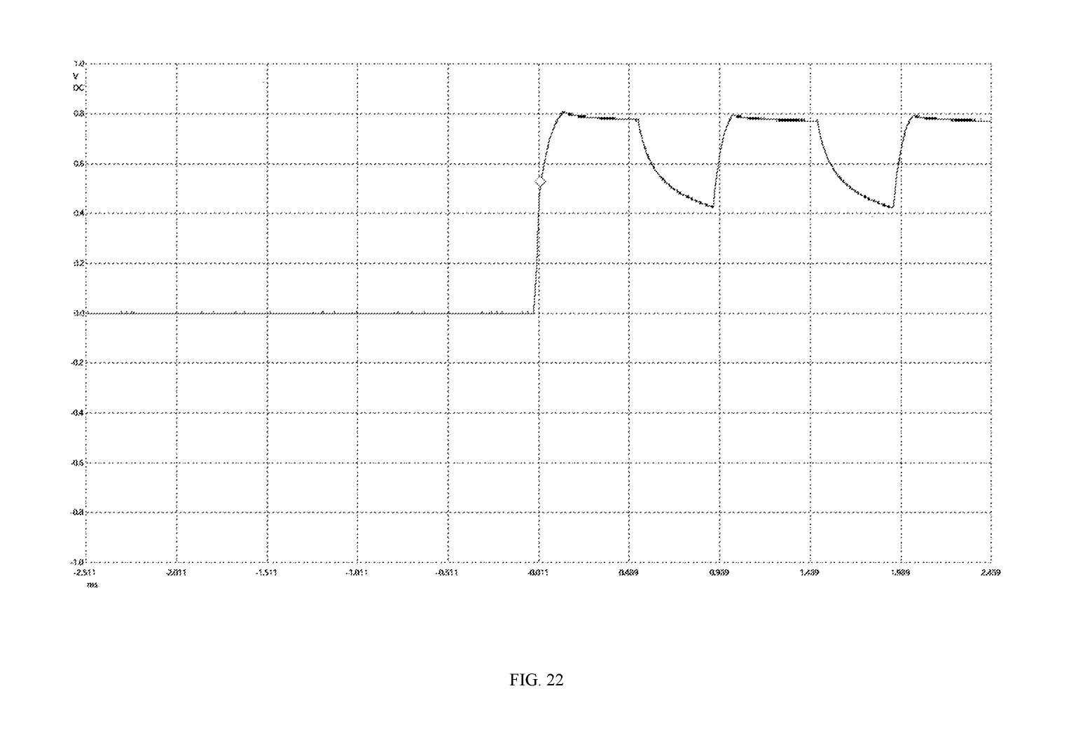

FIG. 22 shows a voltage waveform to illustrate a typical laser output voltage. The PCB 130 controls the laser light source 8 of the laser projection device 1 using pulse width modulation (PWM). PWM provides a plurality of cycles each comprising an ON portion and an OFF portion.

An output power is preselected that ultimately provides a laser image which is as bright as possible without exceeding eye safety regulations. An operating current of the laser during the ON portion is selected such that the laser operates at its maximum efficiency. Then the percentage of the cycle occupied by the ON portion is set to provide the preselected output power.

Various alternatives and modifications within the scope of the invention will be apparent to those skilled in the art. For example, the embodiment described above has wheel circumference information defined in the PCB firmware. This is because the described embodiment is primarily intended to be retrofitted to a range of rental bicycles which all have the same wheel circumference. However, if the invention is sold as a retail unit for customers to fit to their own bicycles, the wheel circumference information may be changeable by a user (for example, by using the programming method via an optical adaptor as described above). This would also allow the laser projection device and power unit to be removed from a bicycle and used on a bicycle with a different wheel circumference.

What is claimed is:

1. A laser projection device for attachment to a bicycle, the device comprising:
a laser light source operable to emit a beam of laser light in a first direction;
a mirror; and
a diffractive optical element,
the arrangement being such that, in use, a beam of laser light emitted by the laser light source is reflected by the mirror through the diffractive optical element and emitted from the device in a second direction, said second direction being non-parallel to said first direction.

2. A laser projection device according to claim 1, wherein the mirror is held by a mirror holder, the diffractive optical element is held by a diffractive optical element holder, and, in use, the mirror is clamped between the mirror holder, an intermediate piece and the diffractive optical element holder.

3. A laser projection device according to claim 2, wherein the mirror holder has an angled seat portion which is angled obliquely to the beam of laser light emitted by the laser light source in use and dimensioned to receive the mirror.

4. A laser projection device according to claim 3 wherein the intermediate piece comprises a pair of projecting arms, said arms each having a respective angled portion whose angle corresponds to the angle of the angled seat portion, and, in use the projecting arms act to clamp the peripheral portions of the mirror to the mirror holder.

5. A laser projection device according to claim 2, wherein the diffractive optical element holder comprises an aperture dimensioned to receive a portion of the diffractive optical element and prevent rotation thereof.

6. A laser projection device according to claim 2, wherein the laser light source, mirror, mirror holder, intermediate piece, diffractive optical element and diffractive optical element holder are contained within a housing.

7. A laser projection device according to claim 6, wherein the diffractive optical element holder comprises at least one projecting arm comprising an internal bore which is hollowed to receive a self-tapping screw.

8. A laser projection device according to claim 7, wherein the housing comprises an aperture, and a screw is passed through said aperture to secure the diffractive optical element holder to the housing.

9. A laser projection device according to claim 8, wherein the diffractive optical element, diffractive optical element holder, intermediate piece, mirror and mirror holder are arranged in a stack, such that tightening of the screw draws the diffractive optical element holder towards the housing to compress the stack together.

10. (canceled)

11. (canceled)

12. (canceled)

13. (canceled)

14. (canceled)

15. A laser projection device according to claim 1, wherein said second direction is substantially perpendicular to said first direction.

16. A method of projecting a laser light image onto a surface from a bicycle, the method comprising the steps of:
providing a laser light source, a mirror and a diffractive optical element on the bicycle;
causing the laser light source to emit a beam of laser light in a first direction;
reflecting the beam of laser light by the mirror through the diffractive optical element; and
emitting the reflected beam of laser light from the device in a second direction, said second direction being non-parallel to said first direction, to produce a laser light image on the surface.

17. A method according to claim 16, wherein the mirror is held by a mirror holder, the diffractive optical element is held by a diffractive optical element holder, and, in use, the mirror is clamped between the mirror holder, and intermediate piece and the diffractive optical element holder.

18. A method according to claim 17, wherein the mirror holder has an angled seat portion which is angled obliquely to the beam of laser light emitted by the laser light source in use and dimensioned to receive the mirror.

19. A method according to claim 18, wherein the intermediate piece comprises a pair of projecting arms, said arms each having a respective angled portion whose angle corresponds to the angle of the angled seat portion, and, in use the projecting arms act to clamp the peripheral portions of the mirror to the mirror holder.

20. A method according to claim 19, wherein, in use, the diffractive optical element is clamped between the diffractive optical element holder and the intermediate piece.

21. A method according to claim 20, wherein the diffractive optical element holder comprises a recess dimensioned to receive a portion of the diffractive optical element and prevent rotation thereof.

22. A method according to claim 17, wherein the laser light source, mirror, mirror holder, intermediate piece, diffractive optical element and diffractive optical element holder are contained within a housing, and wherein the diffractive optical element holder comprises at least one projecting arm comprising an internal bore which is hollowed receive a self-tapping screw.

23. (canceled)

24. A method according to claim 22, wherein the housing comprises an aperture, and a screw is passed through said aperture to secure the diffractive optical element holder to the housing, and wherein the diffractive optical element, diffractive optical element holder, intermediate piece, mirror and mirror holder are arranged in a stack, such that tightening of the screw draws the diffractive optical element holder towards the housing to compress the stack together.

25. (canceled)

26. (canceled)

27. (canceled)

28. (canceled)

29. (canceled)

30. (canceled)

31. A method according to claim 16, wherein said second direction is substantially perpendicular to said first direction.

32. A method of retrofitting a bicycle with a laser projection device, the bicycle having a dynamo electrically connected to conventional lighting, the method comprising the steps of:
disconnecting the dynamo from the conventional lighting;
electrically connecting the dynamo to a power unit containing a rechargeable cell, said cell being connected to a laser projection device according to claim 1 and configured to supply electrical power thereto; and
connecting the conventional lighting to the electrical connection between the dynamo and the power unit.

33. (canceled)

34. (canceled)

35. (canceled)

36. (canceled)
